(19) United States
(12) Patent Application Publication
(10) Pub. No.: US 2005/0226227 A1
(43) Pub. Date: Oct. 13, 2005

(54) Apparatus and method for processing voice packet data in a mobile communication system providing voice service using packet network

(75) Inventors: Soeng-Hun Kim, Suwon-si (KR); Sung-Ho Choi, Suwon-si (KR); Kook-Heui Lee, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/103,814

(22) Filed: Apr. 12, 2005

(30) Foreign Application Priority Data
Apr. 12, 2004 (KR) 25138-2004
May 25, 2004 (KR) 37577-2004
Aug. 17, 2004 (KR) 64783-2004

(51) Int. Cl. H04L 12/66

(52) U.S. Cl. 370/352

(57) ABSTRACT

An apparatus and method for efficiently processing a voice packet in a mobile communication system. Upon receiving information related to a type of a voice frame of an adaptive multi-rate (AMR) codec and information related to an operation mode of the AMR codec from a core network, a radio network controller (RNC) classifies a voice packet received from the core network into three classes according to the received information. The RNC sets up transport channels such that the classified three classes independently undergo error protection and error detection according to their priority.

### PRIORITY

This application claims priority under 35 U.S.C. § 119 to an application entitled “Apparatus and Method for Processing Voice Packet Data in a Mobile Communication System Providing Voice Service Using Packet Network” filed in the Korean Intellectual Property Office on Apr. 12, 2004 and assigned Serial No. 2004-25138, an application entitled “Apparatus and Method for Processing Voice Packet Data in a Mobile Communication System Providing Voice Service Using Packet Network” filed in the Korean Intellectual Property Office on May 25, 2004 and assigned Serial No. 2004-37577, and an application entitled “Apparatus and Method for Processing Voice Packet Data in a Mobile Communication System Providing Voice Service Using Packet Network” filed in the Korean Intellectual Property Office on Aug. 17, 2004 and assigned Serial No. 2004-64783, the contents of all of which are incorporated herein by reference.

### BACKGROUND OF THE INVENTION

1. Field of the Invention

The present invention relates generally to voice service in a mobile communication system, and in particular, to an apparatus and method for efficiently processing a voice packet for the voice service.

2. Description of the Related Art

These days, a mobile communication system is developing into a high-speed, high-quality wireless data packet communication system for providing data service and multimedia service for beyond the earlier voice-oriented services. A Universal Mobile Telecommunication Service (UMTS) system, a 3^{rd} generation (3G) mobile communication system which is based on Global System for Mobile communications (GSM) and General Packet Radio Services (GPRS) which are European mobile communication systems and use Wideband Code Division Multiple Access (CDMA), provides a consistent service capable of transmitting packet-based text, digitalized voice/video and multimedia data at a high rate of 2 Mbps or more throughout the world. The UMTS system employs a packet-switched access concept that uses a packet protocol such as an Internet Protocol (IP), and can always access any terminal in a network.

In 3^{rd} Generation Partnership Project (3GPP) in charge of the standardization for the UMTS communication system, a scheme for supporting Voice-over-Internet Protocol (VoIP) communication is under discussion. The VoIP refers to a communication technique of changing voice frames generated by a voice codec into an IP/User Datagram Protocol (UDP)/Realtime Transport Protocol (RTP) packet before transmission. With the use of the VoIP, it is possible to provide voice service through a packet network.

FIG. 1 is a diagram illustrating architecture of a mobile communication system performing VoIP in a conventional manner. In particular, FIG. 1 illustrates a system in which a user equipment (UE) 100 performs VoIP.

Referring to FIG. 1, the UE 100 includes a codec 106 for converting a voice signal into voice frames, an IP/UDP/RTP layer 105 for changing the voice frames from the codec 106 into an IP/UDP/RTP packet, a Packet Data Convergence Protocol (PDCP) layer 104 for compressing the IP/UDP/RTP packet, a Radio Link Control (RLC) layer 103 for converting the IP/UDP/RTP packet into an appropriate format to transmit the IP/UDP/RTP packet through a radio channel, and a Medium Access Control (MAC) layer 102, and a Physical (PHY) layer 101 for transmitting the packet data through a radio channel.

Voice packet data transmitted by the UE 100 is delivered to a radio network controller (RNC) 120 through a PHY layer 111 of a Node B 110. The RNC 120, which includes, like the UE 100, a MAC layer 122, an RLC layer 123 and a PDCP layer 124, converts the received data into its original IP/UDP/RTP packet and transmits the IP/UDP/RTP packet to a core network (CN) 130. The IP/UDP/RTP packet is transmitted to the other party through an IP network 140. In a UE of the other party, the voice data is controlled in the reverse order.

A description will now be made of an operation of the RLC layer.

Generally, the operating modes of the RLC layer are classified into an Unacknowledged Mode (UM), an Acknowledged Mode (AM) and a Transparent Mode (TM). The VoIP operates in the RLC UM mode, and a description of an operation in the RLC UM mode will be made below.

A transmission side RLC UM layer creates an RLC Service Data Unit (SDU) provided from an upper layer in a size appropriate for transmission through a radio channel by segmentation, concatenation or padding, and creates an RLC Protocol Data Unit (PDU) by inserting segmentation/concatenation/padding information and a serial number therein. The RLC PDU is delivered to a lower layer.

Then a reception side RLC UM layer analyzes the serial number and segmentation/concatenation/padding information of the RLC PDU provided from a lower layer, reconfigures an RLC SDU, and delivers the RLC SDU to an upper layer.

An RLC TM layer delivers an RLC SDU provided from an upper layer to a lower layer as is, or delivers an RLC PDU provided from the lower layer to the upper layer as is.

As described above, voice data generated by the codec 106 of the UE 110 is converted into a VoIP packet through the IP/UDP/RTP protocol stack 105. The VoIP packet, a header of which is compressed through the PDCP layer 104 provided for the uplink transmission, is configured in a size appropriate for radio channel transmission through the RLC layer 103, channel-coded in the MAC/PHY layers 102 and 101, and then transmitted through a radio channel. The RLC PDU (or RLC Transport Block: RLC PDU is referred to as an RLC Transport Block after being processed in the PHY layer) is channel-decoded in the PHY layer 111 of the Node B 110 and then transmitted to the RNC 120. The RNC 120 reconfigures the RLC PDUs back into a VoIP packet, and transmits the VoIP packet to the core network 130. The core network 130 delivers the VoIP packet to the other party through the IP network 140 or a Public Service Telephone Network (PSTN) 150. Downlink data transmission is performed in the reverse order.

In VoIP communication, both a calling UE and a called UE should use the same codecs 106 and 144. If a call is made between a UMTS UE 100 and a wire phone 150, a predetermined device serves as a codec 154 between the UMTS network and the PSTN network.

A codec used in the 3GPP includes an Adaptive Multi-Rate (AMR) codec. The AMR codec is featured by Unequal Error Protection/Unequal Error Detection (UEP/UED). Herein, the UEP/UED refers to a scheme for classifying voice data generated by the codec into 3 classes according to the importance of the data, and uniquely applying specialized transmission schemes to the classes.

The 3 classes are generally referred to as Class A, Class B, and Class C, each of which has the following features.

Class-A bit: This is the most important data, and the codec contains information indicating if there is an error in the data. Therefore, a high channel coding rate is used for the data, and a Cyclic Redundancy Check (CRC) is applied to the data to determine if there is an error in the data according to the CRC check result.

Class-B bit: It is preferable that there is no error in this data. However, even though this class data may contain errors, the codec can use the defective data. Therefore, a high channel coding rate is applied to the data. However, as the codec is not required to recognize if there is an error in the data, a CRC is not applied to the data.

Class-C bit: It is preferable that there is no error in this data. However, even though this class data may contain errors, the codec can use the defective data. Here, the codec is not required to recognize if there is an error in the data, and the Class-C voice packet data is lower than the Class-B voice packet data in terms of importance. Therefore, compared with Class B, Class C uses a lower channel coding rate and does not use a CRC.

As described above, the AMR codec should use different error protection schemes and error detection schemes for voice data according to the class of the voice data, and in order to use such UEP/UED, the RNC 120 needs to classify IP packets received from the core network 130 according to the classes.

However, in the conventional VoIP communication scheme, a UMTS Terrestrial Radio Access Network (UTRAN) (including an RNC and a Node B) cannot use UEP/UED for the voice data.

### SUMMARY OF THE INVENTION

It is, therefore, an object of the present invention to provide an apparatus and method for efficiently processing voice packet data in a mobile communication system supporting a voice service through a packet network.

It is another object of the present invention to provide an apparatus and method for efficiently processing voice packet data by a UTRAN in a mobile communication system supporting a voice service through a packet network.

According to one aspect of the present invention, there is provided a transmission apparatus for processing a voice packet in a mobile communication system providing a voice service through a packet network. The apparatus includes a packet disassembler for disassembling a voice packet received from an upper system into first-class data, second-class data and third-class data depending on an adaptive multi-rate (AMR) header including frame information which is divided into three parts according to a priority; a first-class radio bearer unit for adding a padding bit for byte-aligning the first-class data delivered from the packet disassembler and compressing a first-class protocol header, thereby generating a radio channel; a second-class radio bearer unit for converting the second-class data delivered from the packet disassembler into a radio channel; and a third-class radio bearer unit for converting the third-class data delivered from the packet disassembler into a radio channel.

According to another aspect of the present invention, there is provided a reception apparatus for processing a voice packet for a voice service using an adaptive multi-rate (AMR) codec in a mobile communication system providing the voice service through a packet network. The apparatus includes three channel blocks for individually receiving signals through their associated radio channels; a first-class radio bearer unit for converting a signal received from a first channel block from among the channel blocks into first-class data, decompressing a compressed protocol header in the first-class data, and removing a padding bit added for byte aligning; a second-class radio bearer unit for converting a signal received from a second channel block from among the channel blocks into second-class data; a third-class radio bearer unit for converting a signal received from a third channel block from among the channel blocks into third-class data; and a packet assembler for generating one voice packet by assembling the first-class data, the second-class data and the third-class data.

According to further another aspect of the present invention, there is provided a method for receiving a voice packet in a mobile communication system providing a voice service through a packet network. The method includes the steps of receiving from a core network, by a radio network controller (RNC), information on a type of a voice frame of an adaptive multi-rate (AMR) codec and information on an operation mode of the AMR codec for processing the voice frame; classifying the voice packet received from the core network into three classes according to the information; and setting up transport channels such that the classified three classes independently undergo error protection and error detection according to a preset class priority.

According to further another aspect of the present invention, there is provided a method for transmitting a voice packet in a mobile communication system providing a voice service through a packet network. The method includes the steps of receiving from a core network, by a radio network controller (RNC), information on a type of a voice frame of an adaptive multi-rate (AMR) codec and information on an operation mode of the AMR codec for processing the voce frame; compressing a protocol header of the voice packet, and classifying the voice packet received from the core network into three classes according to class priority based on the information; adding a padding bit for byte aligning to a first class among the classified three classes, converting the padding bit-added first class into a radio channel, and setting up a first transport channel such that the radio channel undergoes error protection and error detection; and converting second-class data and third-class data into separate radio channels, and setting up a second transport channel and a third transport channel such that the radio channels independently undergo error protection.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating the architecture of a mobile communication system performing VoIP in a conventional manner;

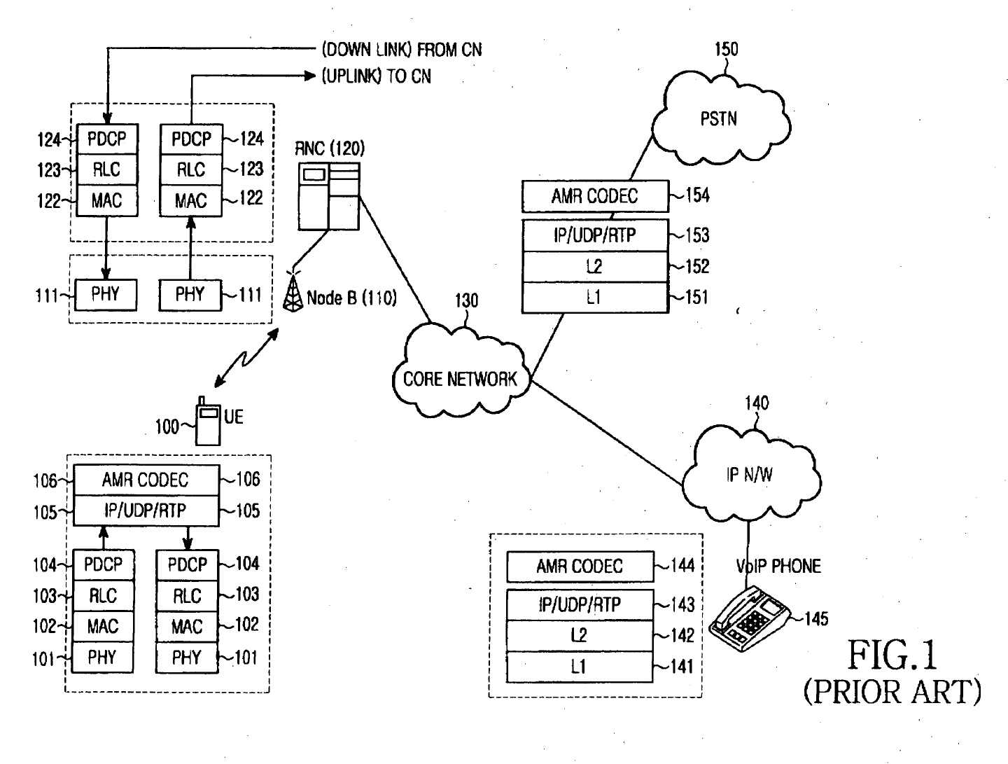

FIG. 2 is a diagram illustrating a format of a VoIP packet to which the present invention is applied;

FIG. 3 is a diagram illustrating network architecture of a mobile communication system supporting a VoIP according to an embodiment of the present invention;

FIG. 4 is a diagram illustrating a structure of a transmitter for transmitting VoIP packet data according to a first embodiment of the present invention;

FIG. 5 is a diagram illustrating a structure of a receiver for receiving VoIP packet data according to the first embodiment of the present invention;

FIG. 6 is a diagram illustrating a structure of a transmitter for transmitting VoIP packet data according to a second embodiment of the present invention;

FIG. 7 is a diagram illustrating a structure of a receiver for receiving VoIP packet data according to the second embodiment of the present invention;

FIG. 8 is a diagram illustrating a structure of a transmitter according to a third embodiment of the present invention;

FIG. 9 is a diagram illustrating a structure of a receiver according to the third embodiment of the present invention;

FIG. 10 is a diagram illustrating a structure of a transmitter according to a fourth embodiment of the present invention;

FIG. 11 is a diagram illustrating a structure of a receiver according to the fourth embodiment of the present invention;

FIG. 12 is a diagram illustrating a structure of a transmitter according to a fifth embodiment of the present invention;

FIG. 13 is a diagram illustrating a structure of a receiver according to the fifth embodiment of the present invention;

FIG. 14 is a diagram illustrating a structure of a transmitter according to a sixth embodiment of the present invention; and

FIG. 15 is a diagram illustrating a structure of a receiver according to the sixth embodiment of the present invention.

### DETAILED DESCRIPTION OF THE PREFERRED EMBODIMENT

Several preferred embodiments of the present invention will now be described in detail with reference to the annexed drawings. In the following description, a detailed description of known functions and configurations incorporated herein has been omitted for conciseness.

The present invention proposes an apparatus and method in which a radio access network (RAN) can use UEP/UED for VoIP service that is serviced through a packet domain of a UMTS core network. Herein, the RAN, which is equalivolent to a UTRAN in terms of its concept, is comprised of a plurality of radio network systems (RNSs). The RNS is comprised of one RNC and a plurality of Node Bs which are lower systems of the RNC.

A description will now be made of a format of a packet for voice service provided through the packet domain.

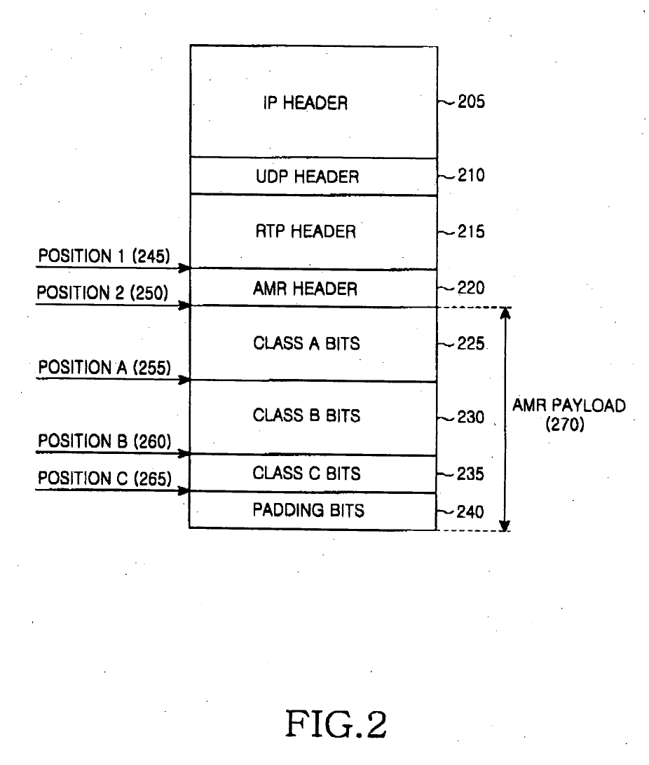

FIG. 2 is a diagram illustrating a format of a VoIP packet to which the present invention is applied. Referring to FIG. 2, a VoIP packet is comprised of an IP Header field 205, a UDP Header field 210, an RTP Header field 215, an AMR Header field 220, a Class-A Bits field 225, a Class-B Bits field 230, a Class-C Bits field 235, and a Padding Bits field 240.

The Class-A Bits field 225, the Class-B Bits field 230, the Class-C Bits field 235, and the Padding Bits field 240 constitute an AMR payload 270. The AMR payload 270 refers to a frame of voice packet data generated by an AMR codec. The sizes of the Class-A Bits field 225, the Class-B Bits field 230, the Class-C Bits field 235, and the Padding Bits field 240 are determined according to a type of the frame. In the AMR codec, 8 voice frames and 1 silent period frame are defined. Table 1 illustrates the number of bits for each class for each frame type.

TABLE 1

| | Frame content (AMR | | | |
|---|---|---|---|---|
| Frame | mode, comfort noise, or | | | |
| Type | other) | CLASS A | CLASS B | CLASS C |
| 0 | AMR 4.75 kbit/s | 42 | 53 | 0 |
| 1 | AMR 5.15 kbit/s | 49 | 54 | 0 |
| 2 | AMR 5.90 kbit/s | 55 | 63 | 0 |
| 3 | AMR 6.70 kbit/s (PDC- | 58 | 76 | 0 |
| | EFR) | | | |
| 4 | AMR 7.40 kbit/s (TDMA- | 61 | 87 | 0 |
| | EFR) | | | |
| 5 | AMR 7.95 kbit/s | 75 | 84 | 0 |
| 6 | AMR 10.2 kbit/s | 65 | 99 | 40 |
| 7 | AMR 12.2 kbit/s (GSM- | 81 | 103 | 60 |
| | EFR) | | | |
| 8 | AMR SID | 39 | 0 | 0 |

In Table 1, SID denotes a frame generated in a silent period, and serves to generate a comfort noise.

The AMR codec has 2 operating modes: a Bandwidth Efficient (BE) mode and an Octet-Aligned (OA) mode, which is intentionally inserted during a silent period.

The BE mode is a scheme for fully byte-aligning an AMR header and an AMR payload, and the OA mode is a scheme for individually byte-aligning the AMR header and the AMR payload. For example, if the AMR header has x bits and the AMR payload, has y bits, a padding is inserted into (x+y) bits in the BE mode. However, in the OA mode, a padding is individually inserted into x bits and a padding is inserted into the y bits. In one aspect the BE mode is different from the OA mode in size of the padding 240.

The AMR header 220 includes frame type information indicating a type of a frame. If one or more voice frames are contained in an AMR payload, several frame type information pieces are inserted in the AMR header 220. Therefore, the size of the AMR header 220 is variable. However, in the general VoIP communication, because the AMR payload does not contain a plurality of voice frames, the present invention will be described on the assumption that one AMR payload contains only one voice frame.

When one AMR payload contains one voice frame, the size of the AMR header 220 is 10 bits in the BE mode and 24 bits in the OA mode. Table 2 and Table 3 illustrate a size of the padding 240 for each frame. Table 2 illustrates a padding size and the total size in the BE mode.

TABLE 2

| | Frame content (AMR | | | |
|---|---|---|---|---|
| | mode, comfort noise, | padding | AMR | |
| Frame Type | or other) | bits | header | Total size |
| 0 | AMR 4.75 kbit/s | 7 | 10 | 112 |
| 1 | AMR 5.15 kbit/s | 7 | 10 | 120 |
| 2 | AMR 5.90 kbit/s | 0 | 10 | 128 |
| 3 | AMR 6.70 kbit/s (PDC- | 0 | 10 | 144 |
| | EFR) | | | |
| 4 | AMR 7.40 kbit/s | 2 | 10 | 160 |
| | (TDMA-EFR) | | | |
| 5 | AMR 7.95 kbit/s | 7 | 10 | 176 |
| 6 | AMR 10.2 kbit/s | 2 | 10 | 216 |
| 7 | AMR 12.2 kbit/s (GSM- | 2 | 10 | 256 |
| | EFR) | | | |
| 8 | AMR SID | 7 | 10 | 56 |

Table 3 illustrates a padding size and the total size in the OA mode.

TABLE 3

| | Frame content (AMR | | | |
|---|---|---|---|---|
| | mode, comfort noise, | padding | AMR | |
| Frame Type | or other) | bits | header | Total size |
| 0 | AMR 4.75 kbit/s | 1 | 24 | 120 |
| 1 | AMR 5.15 kbit/s | 1 | 24 | 128 |
| 2 | AMR 5.90 kbit/s | 2 | 24 | 144 |
| 3 | AMR 6.70 kbit/s (PDC- | 2 | 24 | 160 |
| | EFR) | | | |
| 4 | AMR 7.40 kbit/s | 4 | 24 | 176 |
| | (TDMA-EFR) | | | |
| 5 | AMR 7.95 kbit/s | 1 | 24 | 184 |
| 6 | AMR 10.2 kbit/s | 4 | 24 | 232 |
| 7 | AMR 12.2 kbit/s (GSM- | 4 | 24 | 272 |
| | EFR) | | | |
| 8 | AMR SID | 1 | 24 | 64 |

In Table 2 and Table 3, “padding bits” correspond to the Padding Bits field 240 of FIG. 2, and “Total size” refers to the sum of the AMR header 220 and the AMR payload 270.

The IP header 205 is allocated such information as an IP address. The UDP header 210 is allocated such information as a port number. The RTP header 215 is allocated such information as a serial number. Because the headers are not directly related to the present invention, a detailed description thereof will be omitted.

The VoIP packet configured in this manner is delivered to an RNC through an UMTS core network in a forward direction, and delivered to a PDCP layer of an upper layer in a UE in a reverse direction.

For convenience of description, a definition of several terms will be given below.

Position #1 245: This represents a point where an RTP header ends in a particular VoIP packet. This can be distinguished by sequentially analyzing IP/UDP/RTP headers of the VoIP packet.

Position #2 250: This represents a point where an AMR header ends in a particular VoIP packet. This can be distinguished by analyzing the AMR header of the VoIP packet.

Position #A 255: This represents a point where all of the Class-A bits are included in a particular VoIP packet. This can be distinguished by analyzing a frame type in the AMR header.

Position #B 260: This represents a point where all of the Class-B bits are included in a particular VoIP packet. This can be distinguished by analyzing the frame type in the AMR header.

Position #C 265: This represents a point where all of the Class-C bits are included in a particular VoIP packet. This can be distinguished by analyzing the frame type in the AMR header.

The present invention includes a device for processing a voice packet for VoIP service in a UE and an RNC, to classify the AMR payloads according to a class based on frame type information in the AMR header. The classified packets are transmitted with a radio channel through transport channels appropriately configured for the respective classes.

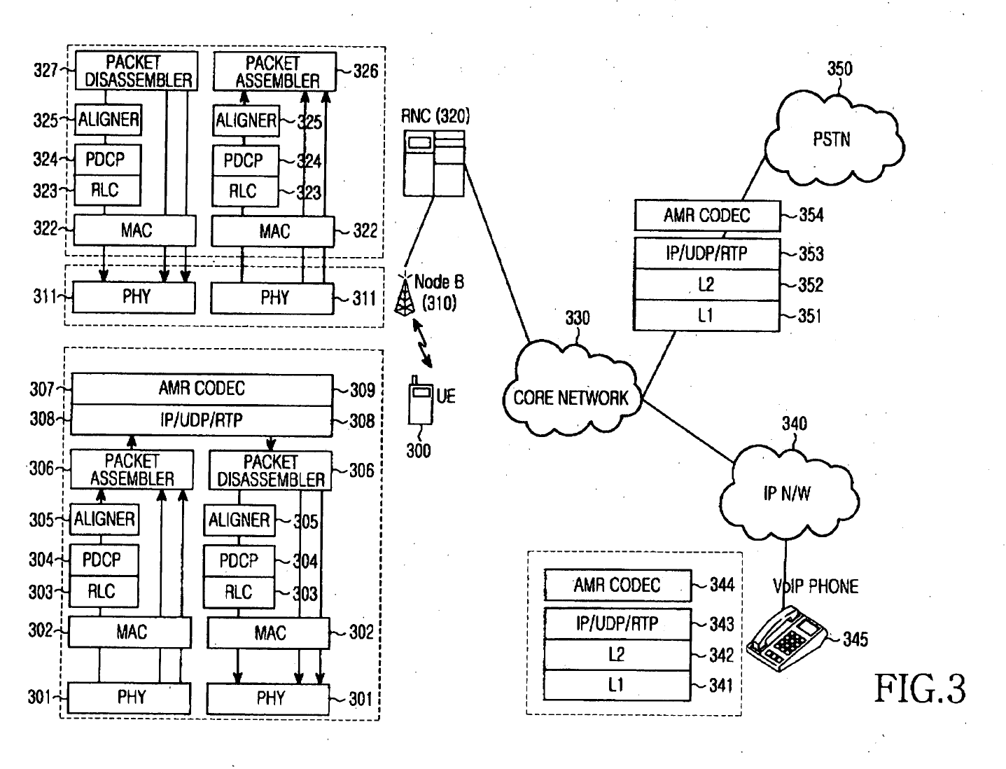

FIG. 3 is a diagram illustrating network architecture of a mobile communication system supporting VoIP according to an embodiment of the present invention. [Referring to FIG. 3, a device for processing a downlink VoIP packet in a UE 300 includes an AMR codec 309, IP/UDP/RTP protocol entities 308, radio bearers for the respective classes (three solid lines represent the respective radio bearers), and a packet assembler 307.

In a downlink, a downlink PHY layer 301 receives downlink signals, processes the downlink signals according to transport channel, and delivers the processed downlink signals to a MAC layer 302. The MAC layer 302 can be uniquely configured for a radio bearer for each class, or one MAC layer 302 can service all of the radio bearers. In FIG. 3, it is shown that one MAC layer 302 supports all of the radio bearers. The MAC layer 302, like the RLC TM layer, does not perform a separate operation in terms of a protocol. That is, the MAC layer 302 does not supplementally add header information. The transport channel is a data transmission path between the MAC layer 302 and the PHY layer 301, and is a logical channel defining a scheme with which a PHY layer processes a signal. In FIG. 3, transport channels are not separately illustrated, and three solid lines connected between the MAC layer 302 and the PHY layer 301 represent the respective transport channels. Data processed through a transport channel A is delivered to the packet assembler 307 through an RLC VoIP 303 and a PDCP 304 and an aligner 305. Data processed through a transport channel B is delivered to the packet assembler 307 through the RLC TM layer. Data processed through a transport channel C is delivered to the packet assembler 307 through the RLC TM layer. The RLC TM layer does not perform a separate operation in terms of a protocol. That is, the RLC TM layer does not supplementally add header information. FIG. 3 does not illustrate separate RLC TM layers in radio bearers for Class B and Class C. The packet assembler 307, as described above, serves to assemble packets delivered by radio bearers for respective classes into one VoIP packet.

An uplink is comprised of the AMR codec 309, the IP/UDP/RTP protocol entities 308, a packet disassembler 306, radio bearers for the respective classes, a MAC layer, and an uplink PHY layer. The packet disassembler 306 disassembles a VoIP packet delivered from an upper layer into a part A, a part B and a part C, and removes a padding #1. An uplink Class-A radio bearer is comprised of an RLC VoIP layer, a PDCP layer, an aligner, and a transport channel A, and a Class-B radio bearer and a Class-C radio bearer are comprised of an RLC TM layer, a transport channel B and a transport channel C. The RLC TM layer performs no operation in terms of a protocol. That is, the RLC TM layer does not supplementally add separate header information. For convenience, RLC TM layers are not illustrated in the Class-A radio bearer and the Class-B radio bearer in the drawing. The MAC layer 302 can be uniquely configured for a radio bearer for each class, or one MAC layer 302 can service all radio bearers. In FIG. 3, it is shown that one MAC layer 302 supports all radio bearers. The MAC layer 302, like the RLC TM layer, performs no operation in terms of a protocol. That is, the MAC layer 302 does not add separate header information. The uplink PHY layer 301 processes data delivered by the radio bearers for the respective classes, and transmits the processed data with a radio channel.

The RNC is equivalent to the UE in structure except that in an upper system, a PHY layer is included in a Node B.

Generally, VoIP communication can be performed between the UE 300 and a PSTN(Public Switched Telephone Network) 350. In this case, a call is set up between the UE 300 and the wire phone 350, and a path of the call is formed by the UE 300, an RNC 320, a UMTS core network 330, a PSTN network 350, and the wire phone. An IP N/W 340 generally uses a codec different from the AMR codec. Therefore, between the PSTN 350 and the UMTS core network 330, a particular device such as an AMR codec 354 serves to convert voice data delivered through the PSTN 350 into a VoIP packet. That is, between such a conversion device as the AMR codec 354 and the RNC 320, voice data is converted into a VoIP packet, and when the VoIP packet is delivered in the PSTN 350, an operation of converting the VoIP packet into voice data should be performed. Voice data generated in the wire phone 350 is delivered to the converter 354 through the PSTN, and the converter 354 converts the voice data into a VoIP packet and delivers the VoIP packet to the UMTS core network 330. The VoIP packet is delivered to the RNC 320 via the core network 330, and a packet disassembler 327 in the RNC 320 disassembles the VoIP packet into a part A, a part B and a part C, classifies the part A, the part B and the part C according to its class, and transmits the classified data to the UE 300. The packet assembler 307 in the UE 300 reconfigures the classified data for the respective classes into one VoIP packet, and delivers the VoIP packet to an upper layer.

A VoIP packet generated in the UE 300 is transmitted to the wire phone 340 in the reverse process of the foregoing process. The VoIP communication can also be performed between the UE 300 and the VoIP phone 340. In this case, a path of the call is formed by the UE 300, the RNC 320, the UMTS core network 330, and the IP network 340. The VoIP phone 340 should include an AMR codec 344. If the VoIP phone 340 includes a codec different from the AMR codec 344, a particular conversion device should be established between the UE 300 and the VoIP phone 345.

Voice data generated in the VoIP phone 345 is encapsulated by IP/UDP/RTP protocol entities 343 after passing through the AMR codec 344, and then transmitted to the IP network 340 via an L2 layer 342 and an L1 layer 341. The VoIP packet is delivered to the RNC 320 via the IP network 340 and the UMTS core network 330. In the RNC 320, the VoIP packet is disassembled into individual data for the respective classes by the packet disassembler 327 and then transmitted to the UE 300. The packet assembler 307 in the UE 300 reconfigures the classified data for the respective classes into one VoIP packet, and delivers the VoIP packet to an upper layer. A VoIP packet generated in the UE 300 is transmitted to the VoIP phone 345 in the reverse order of the foregoing process.

In order for the RNC 320 and the UE 300 to deliver a VoIP packet through the foregoing process, the core network 330 delivers control information such as VoIP codec information and AMR operation mode information to the RNC 320. The VoIP codec information represents frame type information for a voice frame to be transmitted through an established communication path, and the AMR operation mode information represents the BE mode or the OA mode.

Upon receiving the control information from the core network 330, the RNC 320 configures radio bearers in the following order.

First, the RNC 320 creates a packet disassembler and a packet assembler if the frame type information is included in the received the VoIP codec information.

Second, the RNC 320 sets up a radio bearer for each class according to the frame type. Herein, the RNC 320 sets the RLC TM for a Class-B radio bearer and a Class-C radio bearer, and sets an RLC PDU size such that the Class B and the Class C should be equal to each other in terms of the RLC PDU size. In addition, the RNC 320 configures a Class-A radio bearer through an aligner 325, a PDCP layer 324 and a RLC VoIP layer 323.

Third, the RNC 320 sets up a transport channel A, a transport channel B and a transport channel C according to features of the respective classes. Finally, the RNC 320 delivers configuration information of the 3 radio bearers to the UE 300. At the same time, the RNC 320 delivers information for instructing the creation of the packet assembler 307 and the packet disassembler 306 to the UE 300.

Then the UE 300 sets up a Class-A radio bearer, a Class-B radio bearer and a Class-C radio bearer and creates the packet assembler 307 and the packet disassembler 306 depending on the control information from the RNC 320.

### First Embodiment

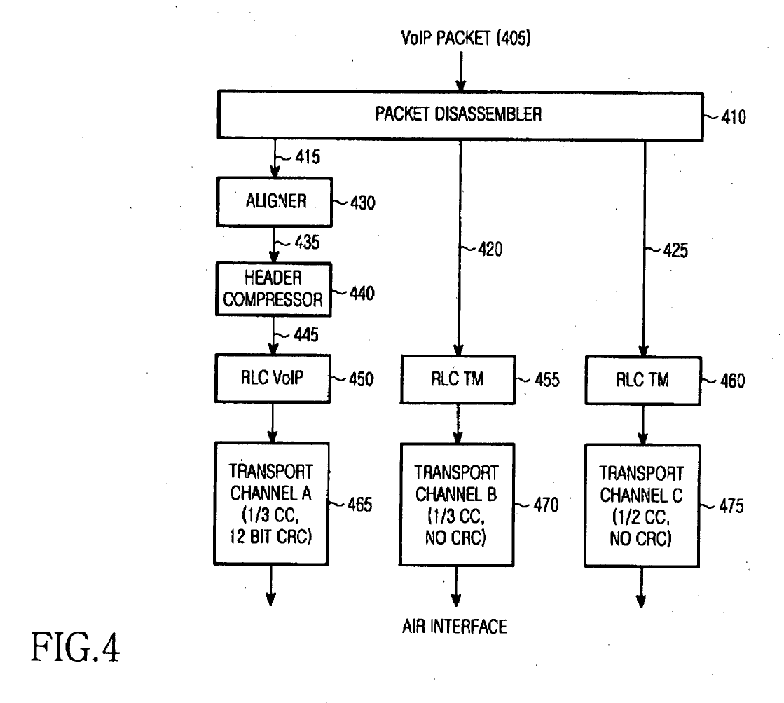

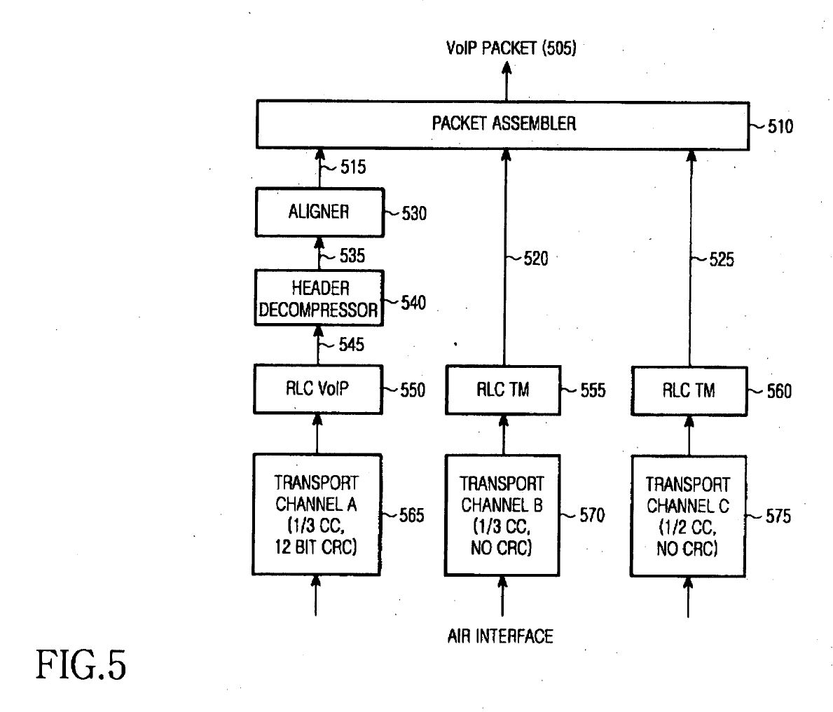

With reference to FIGS. 4 and 5, a description will now be made of a case in which a packet disassembler and a packet assembler are located in an upper layer of a header compressor according to a first embodiment of the present invention.

FIG. 4 is a diagram illustrating a structure of a transmitter for transmitting VoIP packet data according to the first embodiment of the present invention. Referring to FIG. 4, the transmitter includes a packet disassembler 410, and a Class-A radio bearer unit, a Class-B radio bearer unit and a Class-C radio bearer unit, each of which processes data for its respective class.

The packet disassembler 410 disassembles a VoIP packet 405 received from the upper layer 320 or the core network 330 into data for the respective classes, and distributes the disassembled data to the radio bearer units associated therewith.

The Class-A radio bearer unit is a unit for processing an IP/UDP/RTP header part, an AMR header part and Class-A bits delivered by the packet disassembler 410 and transmitting the processing results with a radio channel, and is comprised of an aligner 430, a header compressor 440, an RLC VoIP layer 450 and a transport channel 465 for processing Class-A bits.

The Class-B radio bearer unit is a unit for processing Class-B bits delivered by the packet disassembler 410 and transmitting the processing results with a radio channel, and is comprised of an RLC entity 455 operating in the TM mode and a transport channel 470 for processing Class-B bits.

The Class-C radio bearer unit is a unit for processing Class-C bits delivered by the packet disassembler 410 and transmitting the processing results with a radio channel, and is comprised of an RLC entity 460 operating in the TM mode and a transport channel 475 for processing Class-C bits.

A detailed description will now be made of operations of the respective entities.

The packet disassembler 410 disassembles the received VoIP packet into several parts, and removes padding bits inserted therein for byte aligning. That is, the packet disassembler 410 appropriately disassembles the VoIP packet based on an AMR header of the VoIP packet received from the core network 330 or the upper layer 320. The AMR header has a Frame Type field, and the Frame Type field includes information indicating a format of an AMR payload. The AMR codec can operate in the BE mode or the OA mode, and a format of the packet is changed according to the operation mode, as illustrated in Table 2 and Table 3.

Depending on the set operation mode, the packet disassembler 410 separates padding bits 240 from a payload field of the received VoIP packet, and classifies the remaining payloads according to class.

For the classification, the packet disassembler 410 first analyzes a Frame Type field in the 10-bit or 24-bit AMR header 220 between the Position #1 245 indicating a point where IP/UDP/RTP headers of the received VoIP packet ends and the Position #2 250 indicating a point where the AMR header 220 ends. The packet disassembler 410 distinguishes the Position #A 255 indicating a point where Class A ends, the Position #B 260 indicating a point where Class B ends, and the Position #C 265 indicating a point where Class C ends using Table 2 and Table 3.

For example, if Frame Type is 7 in Table 1, the Position #A indicates a point distanced from the Position #2 by 81 bits, the Position #B indicates a point distanced from the Position #A by 103 bits, and the Position #C indicates a point distanced from the Position #B by 60 bits. The packet disassembler 410 disassembles the received packet into a part A between a start point of the received packet and the Position #A, a part B between the Position #A and the Position #B, and a part C between the Position #B and the Position #C, and removes the remaining part of padding bits. The padding bits removed by the packet disassembler 410 will be referred to as a padding #1. The padding #1 represents meaningless bits which are inserted to byte-align the AMR payload, and is always inserted into the last part of the payload. In brief, the packet disassembler 410 disassembles the received VoIP packet into a part A, a part B and a part C, and then removes the remaining bits.

The packet disassembler 410 allocates the part A to a Class-A radio bearer 415, the part B to a Class-B radio bearer 420, and the part C to a Class-C radio bearer 425.

The aligner 430, which is included in only the Class-A radio bearer 415, inserts a padding #2 in order to byte-align the part A, i.e. IP/UDP/RTP header+AMR header+class A, delivered by the packet disassembler 410. A size of the padding #2 is determined by Equation (1).
PADDING₂_{_{size}}=CEILING{(PART_{A}_{_{SIZE/8}})*8−PART_{A}_{_{SIZE}}} (1)

The CEILING function represents the minimum integer exceeding the calculation result. For example, CEILING(0.5) means 1. That is, the aligner 430 byte-aligns the part A using the minimum number of padding bits. As a result, the aligner 430 delivers padding #2-inserted data (IP/UDP/RTP header+AMR header+class A+padding 2) to the header compressor 440.

The header compressor 440 compresses the IP/UDP/RTP headers of the part A delivered by the aligner 430, and delivers the header-compressed part A to the RLC VoIP 450.

The RLC VoIP 450 is an RLC entity that processes the VoIP data, and for example, an RLC UM layer can be used for the RLC VoIP 450. If a new RLC operation mode is introduced in the future in order to support VoIP, the RLC VoIP 450 represents an RLC entity in the new RLC operation mode.

The transport channel-A block 465, a block for forming a transport channel to process the part A delivered through the RLC VoIP 450, supports both error protection and error detection. Given that the part A is important data, the transport channel-A block 465 uses a high channel coding rate of 1/3 and a 12-bit CRC.

The RLC TMs 455 and 460, RLC entities for processing the part-B data and the part-C data, respectively, are equivalent to the conventional RLC TM.

The transport channel-B block 470 forms a transport channel to process the part B delivered through the RLC TM 455, and supports only error protection. Here, channel coding can be performed at a channel coding rate of 1/3.

The transport channel-C block 475 creates a transport channel to process the part C delivered through the RLC TM 460. As the part C is lower than the part B in terms of importance (i.e. priority), the transport channel-C block 475 supports only error protection for the part C and can perform channel coding at a channel coding rate of 1/2.

The foregoing description has been made on the assumption that there is no MAC entity function, taking a protocol for voice communication into consideration. That is, although the foregoing description has been made on the assumption that there is no entity between the RLC entities 450, 455 and 460 and the transport channel blocks 465, 470 and 475, MAC entities may be arranged therebetween in practice.

FIG. 5 is a diagram illustrating a structure of a receiver for receiving VoIP packet data according to the first embodiment of the present invention. Referring to FIG. 5, the receiver includes a packet assembler 510, and a Class-A radio bearer unit, a Class-B radio bearer unit and a Class-C radio bearer unit, each of which processes data for its class.

The Class-A radio bearer unit is comprised of an aligner 530, a header decompressor 540, an RLC VoIP 550, and a transport channel-A block 565 created to process part-A data.

The Class-B radio bearer unit is comprised of an RLC TM 555 and a transport channel-B block 570 created to process Class-B data. The Class-C radio bearer unit is comprised of an RLC TM 560 and a transport channel-C block 575 created to process Class-C data. The transport channel-A block 565, the transport channel-B block 570, and the transport channel-C block 575 are equivalent in structure to the corresponding blocks in the transmitter of FIG. 4.

The packet assembler 510 assembles data received from the respective radio bearers into one VoIP packet. That is, signals received from a radio channel are classified according to transport channel after being processed in a PHY layer, and then delivered to an upper layer (RNC).

Data processed in the transport channel-A block 565 is delivered to the packet assembler 510 through the RLP VoIP 550, the header decompressor 540, and the aligner 530. Data processed in the transport channel-B block 570 is delivered to the packet assembler 510 through the RLC TM entity 555. Data processed in the transport channel-C block 575 is delivered to the packet assembler 510 through the RLC TM entity 560.

The header decompressor 540 receives part-A data delivered through the RLC VoIP 550. The part-A data is comprised of “compressed IP/UDP/RTP header+AMR header+Class A+padding 2.” The header decompressor 540 decompresses the compressed IP/UDP/RTP header of data 545 to create data 535 of “IP/UDP/RTP header+AMR header+Class A+padding 2.” The data 535 is delivered to the aligner 530. The aligner 530 removes a padding #2 from the data 535 and delivers data 515 of “IP/UDP/RTP header+AMR header+Class A” to the packet assembler 510.

Data delivered to the RLC TM 555 is part-B data, and the RLC TM 555 delivers the part-B data to the packet assembler 510. Data delivered to the RLC TM 560 is part-C data, and the RLC TM 560 delivers the part-C data to the packet assembler 510.

The packet assembler 510 assembles the part-A data, the part-B data and the part-C data delivered from the class-A radio bearer unit 515, the class-B radio bearer unit 520 and the class-C radio bearer unit 525, respectively, into one VoIP packet. Thereafter, the packet assembler 510 inserts a padding #1 in order to byte-align the assembled VoIP packet. The packet assembler 510 delivers the padding #1-inserted VoIP packet to the upper layer (RNC) or the core network.

### Second Embodiment

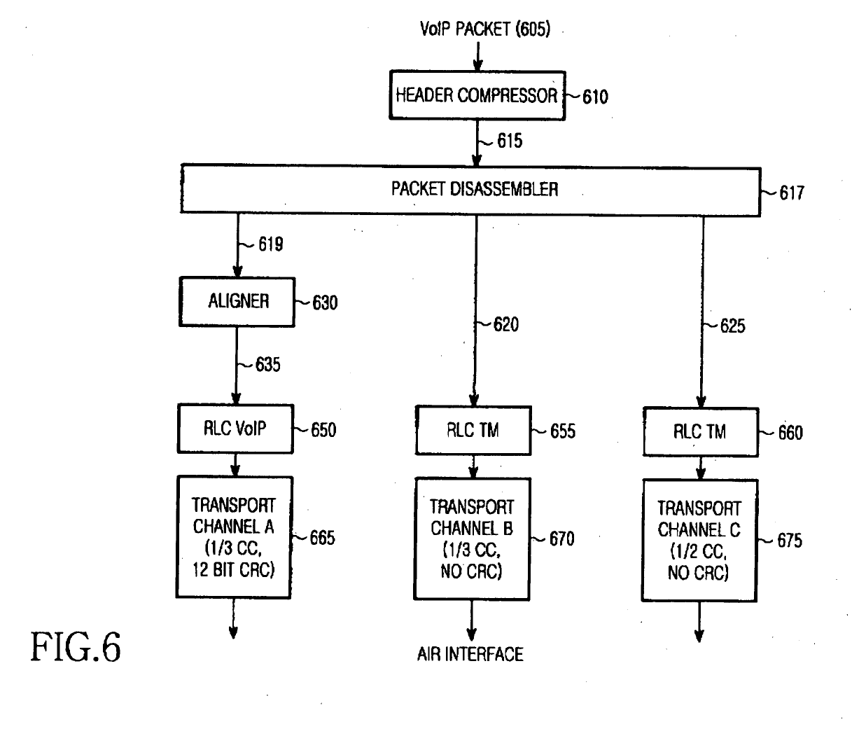

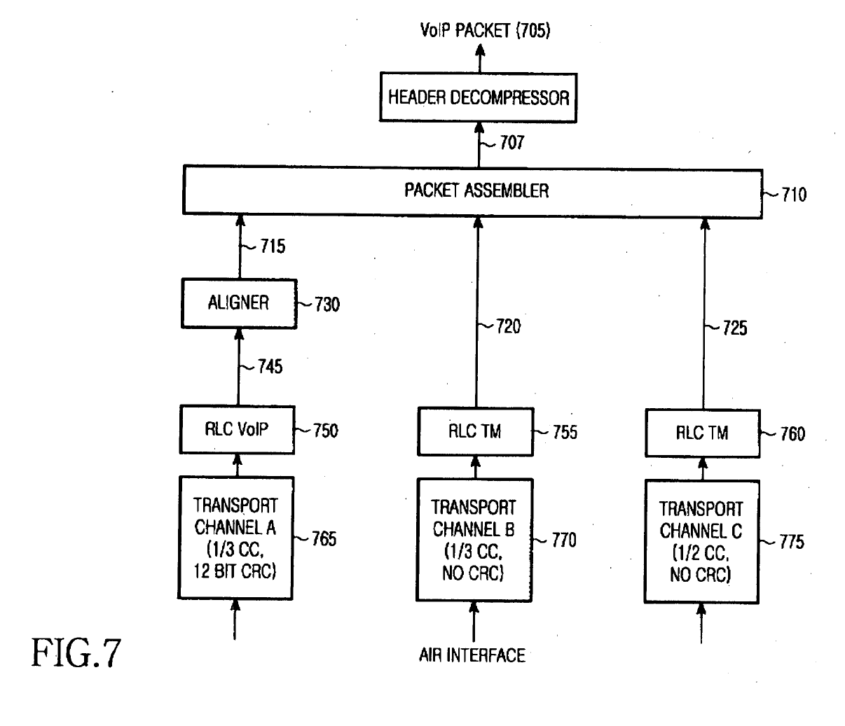

With reference to FIGS. 6 and 7, a description will now be made of a structure for performing header compression on a VoIP packet before packet disassembling according to a second embodiment of the present invention.

FIG. 6 is a diagram illustrating a structure of a transmitter for transmitting VoIP packet data according to the second embodiment of the present invention. Referring to FIG. 6, the transmitter includes a packet disassembler 617, and a Class-A radio bearer unit, a Class-B radio bearer unit and a Class-C radio bearer unit, each of which processes data for its class.

A header compressor 610 compresses IP/UDP/RTP headers of a VoIP packet 605 received from an RNC or a core network. The header compressor 610 delivers the IP/UDP/RTP header-compressed VoIP packet 615 to the packet disassembler 617. The packet disassembler 617 disassembles the VoIP packet 615 delivered by the header compressor 610 into data for the respective classes, and distributes the disassembled data to the radio bearer units associated thereto. The packet disassembler 617 disassembles the received VoIP packet 615 into data for the respective classes and distributes the disassembled data to the corresponding radio bearer units using Frame Type information in an AMR header of the received packet.

The Class-A radio bearer unit transmits the compressed IP/UDP/RTP header part, the AMR header part and the Class-A bits, delivered from the packet disassembler 617, through a radio channel. The Class-A radio bearer unit is comprised of an aligner 630, an RLC VoIP 650, and a transport channel 665 for processing the Class-A bits.

The Class-B radio bearer unit is a unit for processing Class-B bits delivered by the packet disassembler 617 and transmitting the processing results through a radio channel, and is comprised of an RLC entity 655 operating in the TM mode and a transport channel block 670 for processing Class-B bits.

The Class-C radio bearer unit is a unit for processing Class-C bits delivered by the packet disassembler 617 and transmitting the processing results with a radio channel, and is comprised of an RLC entity 660 operating in the TM mode and a transport channel block 675 for processing Class-C bits.

A detailed description will now be made of operations of the respective entities.

The header decompressor 610 decompresses IP/UDP/RTP headers of the VoIP packet delivered via the RNC or the core network, and delivers the IP/UDP/RTP header-compressed VoIP packet to the packet disassembler 617.

The packet disassembler 617 appropriately disassembles the VoIP packet through an AMR header of the received VoIP packet, and removes a padding #1 therefrom. As a detailed operation is equivalent to the corresponding operation in the first embodiment, a description thereof will be omitted.

The aligner 630, which is included only in the Class-A radio bearer, inserts a padding #2 in order to byte-align the part A, i.e. compressed IP/UDP/RTP header+AMR header+class A, delivered by the packet disassembler 617. A size of the padding #2 is determined by Equation (2).
PADDING₂_{_{size}}=CEILING{(PART_{A}_{_{SIZE/8}})*8−PART_{A}_{_{SIZE/}}} (2)

Herein, the CEILING function represents the minimum integer exceeding the calculation result. As a result, the aligner 630 byte-aligns the part A using the minimum number of padding bits. The aligner 630 delivers the padding #2-inserted data (compressed IP/UDP/RTP header+AMR header+class A+padding 2) to the RLC VoIP 650.

The RLC VoIP 650 is an RLC entity that processes the VoIP data, and the VoIP can be supported through the RLC UM mode. In the present invention, the RLC UM mode supports realtime voice service. It is not assumed that the RLC entity operates in a particular RLC mode.

The transport channel-A block 665, a block for forming a transport channel to process the part A delivered through the RLC VoIP 650, supports both error protection and error detection. Given that the part A is important data (i.e. high priority data), the transport channel-A block 665 uses a high channel coding rate of 1/3 and a 12-bit CRC.

The RLC TMs 655 and 660, RLC entities for processing the part-B data and the part-C data, respectively, are equal to the conventional RLC TM.

The transport channel-B block 670 creates a transport channel to process the part B delivered through the RLC TM 655, and supports only error protection. Here, channel coding can be performed at a channel coding rate of 1/3.

The transport channel-C block 675 creates a transport channel to process the part C delivered through the RLC TM 660. As the part C is lower than the part B in terms of importance (i.e. priority), the transport channel-C block 675 supports only error protection for the part C and can perform channel coding at a channel coding rate of 1/2.

FIG. 7 is a diagram illustrating a structure of a receiver for receiving VoIP packet data according to the second embodiment of the present invention. Referring to FIG. 7, the receiver includes a packet decompressor 707, a packet assembler 710, and a Class-A radio bearer unit, a Class-B radio bearer unit and a Class-C radio bearer unit, each of which processes data for its respective class.

The Class-A radio bearer unit is comprised of an aligner 730, an RLC VoIP 750, and a transport channel-A block 765 created to process part-A data.

The Class-B radio bearer unit is comprised of an RLC TM 755 and a transport channel-B block 770 created to process Class-B data.

The Class-C radio bearer unit is comprised of an RLC TM 760 and a transport channel-C block 775 created to process Class-C data. The respective transport channel blocks are equivalent in structure to the corresponding blocks in the transmitter of FIG. 6.

The packet assembler 710 assembles data received from the respective radio bearers into one VoIP packet. Signals received from a radio channel are classified according to transport channel after being processed in a PHY layer, and then delivered to an upper layer.

Data processed in the transport channel-A block 765 is delivered to the packet assembler 710 through the RLP VoIP 750 and the aligner 730. Data processed in the transport channel-B block 770, i.e. the part B, is delivered to the packet assembler 710 through the RLC TM entity 755. Data processed in the transport channel-C block 775, i.e. the part C, is delivered to the packet assembler 710 through the RLC TM entity 760.

Data delivered from the RLC VoIP 750 is part-A data 745, and is comprised of “compressed IP/UDP/RTP header+AMR header+Class A+padding 2.” The data 745 is delivered to the aligner 730, and the aligner 730 removes a padding #2 from the data 745 and delivers the padding #2-removed data 715 of “compressed IP/UDP/RTP header+AMR header+Class A” to the packet assembler 710.

The RLC TM 755 delivers the part-B data 720 to the packet assembler 710. Data delivered to the RLC TM 760 is part-C data 725, and the RLC TM 760 delivers the part-C data to the packet assembler 710.

The packet assembler 710 assembles the part-A data, the part-B data and the part-C data delivered from the class-A radio bearer unit 715, the class-B radio bearer unit 720 and the class-C radio bearer unit 725, respectively, into one VoIP packet. Thereafter, the packet assembler 710 inserts a padding #1 in order to byte-align the assembled VoIP packet. As a result, the padding #1-inserted VoIP packet is comprised of “compressed IP/UDP/RTP header+AMR header+Class A+Class B+Class C+padding 1.” The packet assembler 710 delivers the completed VoIP packet to the header decompressor 707.

The header decompressor 707 decompresses the compressed IP/UDP/RTP header in the received data “compressed IP/UDP/RTP header+AMR header+Class A+Class B+Class C+padding 1.” Thereafter, the header decompressor 707 delivers the header-decompressed VoIP packet “IP/UDP/RTP header+AMR header+Class A+Class B+Class C+padding 1” to the upper layer or the core network.

### Third Embodiment

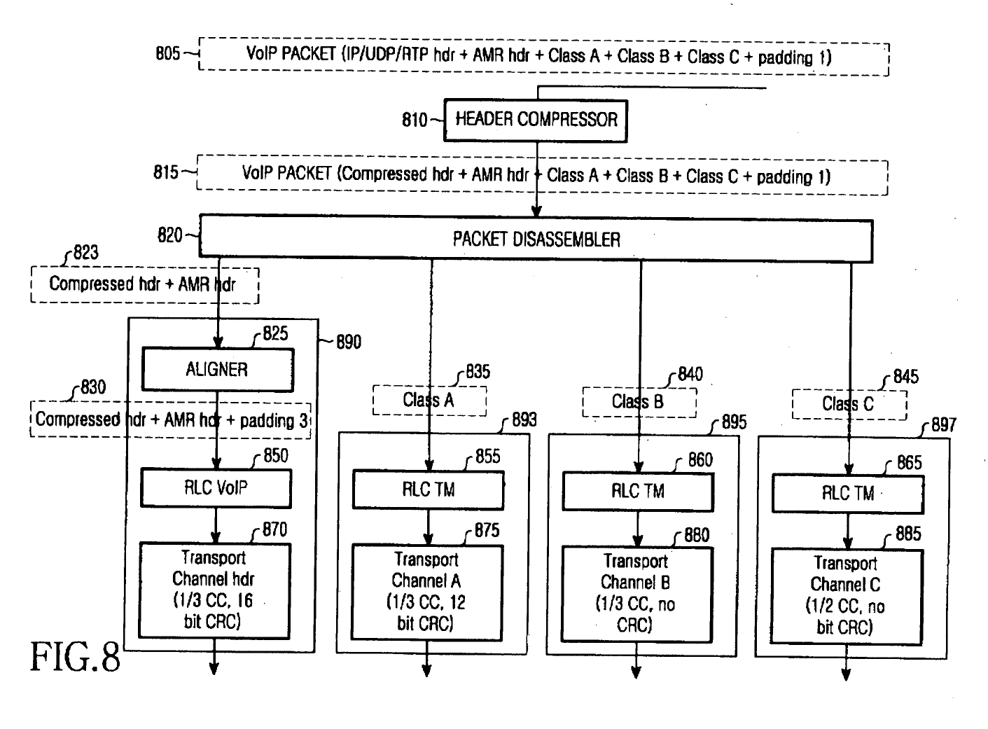

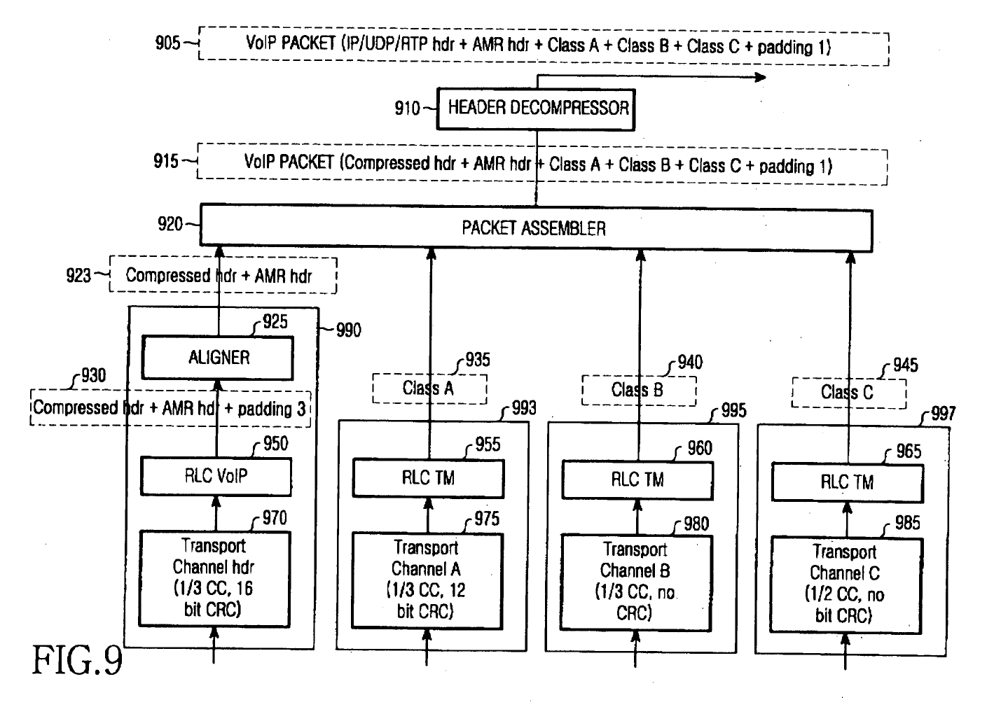

With reference to FIGS. 8 and 9, a description will now be made of a scheme for disassembling a VoIP packet into a header part, a Class-A part, a Class-B part and a Class-C part and transmitting the respective parts through separate transport channels according to a third embodiment of the present invention. In the first and second embodiments, the header part and the Class-A part are assembled and transmitted through a single transport channel as described above. However, as the header part and the Class-A part are different from each other in terms of a transmission feature, it is preferable to separately transmit the header part and the Class-A part.

Specifically, Class-A bits can be used even though there is an error in the Class-A bits. However, if there is an error in the header part, an effective value of the full packet is lost. Therefore, a VoIP packet having a defective header should be discarded. To solve this problem, if the header part and the Class-A part are transmitted with separate data blocks, a reception side can correctly recognize where there is an error in a corresponding VoIP packet and thus can accurately determine whether to discard the VoIP packet.

FIG. 8 is a diagram illustrating a structure of a transmitter according to the third embodiment of the present invention. Referring to FIG. 8, the transmitter includes a header compressor 810, a packet disassembler 820, a header radio bearer 890 for processing header-part data, and a Class-A radio bearer 893, a Class-B radio bearer 895 and a Class-C radio bearer 897, each of which processes data for its respective class.

The header compressor 810 compresses IP/UDP/RTP headers in a VoIP packet 805 received from an upper layer or a core network, based on Robust Header Compression (ROHC). The header-compressed VoIP packet 815 is comprised of “compressed IP/UDP/RTP header+AMR header+Class A+Class B+Class C+padding 1.” The header-compressed VoIP packet 815 is delivered from the header compressor 810 to the packet disassembler 820.

The packet disassembler 820 disassembles the header-compressed VoIP packet 815 into a header part and respective class parts, and removes padding bits. That is, the packet disassembler 820 analyzes an AMR header in the header-compressed VoIP packet 815, disassembles the header-compressed VoIP packet 815 into a header part 823 (including the compressed header part and the AMR header), a Class-A part 835, a Class-B part 840 and a Class-C part 845 according to the analysis result, and removes a padding #1 from the header-compressed VoIP packet 815. The packet disassembler 820 distributes the respective parts 823, 835, 840 and 845 of the disassembled packet to their associated radio bearers 890, 893, 895 and 897 using Frame Type information in the AMR header of the header-compressed VoIP packet 815.

The header radio bearer 890, which is comprised of an aligner 825, an RLC VoIP 850 and a transport channel 870 for header processing, processes the compressed IP/UDP/RTP header and the AMR header delivered from the packet disassembler 820, and transmits the processing results with a radio channel.

The class-A radio bearer 893, which is comprised of an RLC entity 855 and a transport channel 875 for processing Class-A data, processes the Class-A data 835 delivered by the packet disassembler 820 and transmits the processing result with a radio channel. Because a size of the Class-A data 835 is constant, the RLC entity 855 of the Class-A radio bearer 893 can operate in the TM mode. The Class-B radio bearer 895, which is comprised of an RLC entity 860 and a transport channel 880 for processing Class-B bits, processes the Class-B data 840 delivered by the packet disassemble 820 and transmits the processing result over a radio channel. The Class-C radio bearer 897, which is comprised of an RLC entity 865 and a transport channel 885 for processing Class-C bits, processes the Class-C data 845 delivered by the packet disassemble 820 and transmits the processing result over a radio channel.

A detailed description will now be made of operations of respective entities for the radio bearers 890, 893, 895 and 897.

The aligner 825 is included only in the header radio bearer 890. The aligner inserts a padding #3 in order to byte align the header-part data 823 delivered by the packet disassembler 820. A size of the padding #3 is determined by Equation (3).
PADDING₃_{_{SIZE}}=CEILING{(HDR_{SIZE/8})*8HDR_{SIZE}} (3)
where HDR_{SIZE} denote a size of a header part.

The aligner 825 delivers to the RLC VoIP 850 data 830 into which the padding #3 determined by Equation (3) is inserted.

The RLC VoIP 850 is equal in operation to the corresponding element in the first embodiment, so a description thereof will be omitted.

The RLC TM entity 855, the RLC TM entity 860 and the RLC TM entity 865 are RLC entities for processing part-A data, part-B data and part-C data, respectively, and are equivalent to the conventional RLC TM.

The transport channel header 870, which is a transport channel created to process the header part, supports both error protection and error detection. The transport channel header 870 can use more powerful error detection compared with the transport channel A. For example, the transport channel header 870 can use a channel coding rate of 1/3 and a 16-bit CRC. The transport channel A 875 processes the Class-A bits 835, and supports both error protection and error detection. For example, the transport channel A 875 can use a channel coding rate of 1/3 and a 12-bit CRC. A transport channel B 880 processes the part-B data 840, and supports only error protection. For example, the transport channel B 880 can use a channel coding rate of 1/3. The transport channel C 885 processes the part-C data 845, and supports only error protection. For example, the transport channel C 885 can use a channel coding rate of 1/2.

The foregoing transmitter disassembles one VoIP packet into a header part and a payload part, and re-disassembles the payload part into 3 parts according to its class. By doing so, it is possible to grant the most appropriate feature to each part.

FIG. 9 is a diagram illustrating a structure of a receiver according to the third embodiment of the present invention. Referring to FIG. 9, the receiver includes a header decompressor 910, a packet assembler 920, a header radio bearer 990 for processing header-part data 923, and a Class-A radio bearer 993, a Class-B radio bearer 995 and a Class-C radio bearer 997, each of which processes data for its respective class.

The header radio bearer 990, which is comprised of an aligner 925, an RLC VoIP 950 and a transport channel 970 for header processing, processes the compressed IP/UDP/RTP header and the AMR header received through a radio channel, and delivers the processing results to the packet assembler 920.

The Class-A radio bearer 993 is comprised of an RLC entity 955 and a transport channel A 975 for processing Class-A data. The Class-B radio bearer 995 is comprised of an RLC entity 960 and a transport channel B 980 for processing Class-B data. The Class-C radio bearer 997 is comprised of an RLC entity 965 and a transport channel C 985 for processing Class-C data. The RLC entities for the Class-A radio bearer 993, the Class-B radio bearer 995 and the Class-C radio bearer 997 can operate in the TM mode. The transport channel header 970, the transport channel A 993, the transport channel B 995 and the transport channel C 997 are equivalent in structure to the corresponding elements of the transmitter.

The packet assembler 920 assembles headers received from the respective radio bearers 990, 993, 995 and 997, the Class-A data 935, the Class-B data 940 and the Class-C data 945 into one VoIP packet 915.

Signals received from a radio channel are classified according to transport channel after being processed in a PHY layer, and then delivered to an upper layer.

Data processed in the transport channel 990 for header processing is comprised of “compressed IP/UDP/RTP header+AMR header+padding 3” which is output from the RLC VoIP 950, and the output data 930 is delivered to the aligner 925. The aligner 925 removes a padding #3 from the output data 930, and outputs the padding #3-removed header-part data 923 of “compressed IP/UDP/RTP header+AMR header” to the packet assembler 920. The size of the padding #3 is sent to the aligner 925 in a call setup process. Although a size of the compressed IP/UDP/RTP header is variable, it always has a byte unit. The size of the AMR header is constant while a call is maintained. In order words, the size of the padding #3 is constant.

Data processed in the transport channel A 975, which is the Class-A data 935 received through the RLC entity 955, is delivered to the packet assembler 920. Data processed in the transport channel B 980, which is the Class-B data 940 received through the RLC entity 960], is delivered to the packet assembler 920. Data processed in the transport channel C 985, which is the Class-C data 945 received through the RLC entity 965, is delivered to the packet assembler 920.

The packet assembler 920 assembles the header part 923, the Class-A data 935, the Class-B data 940 and the Class-C data 945 delivered from the header radio bearer 990, the Class-A radio bearer 993, the Class-B radio bearer 995 and the Class-C radio bearer 997, respectively, into one VoIP, packet. The packet assembler 920 inserts a padding #1 in order to byte-align the completed VoIP packet, and then delivers the padding #1-inserted VoIP packet to the header decompressor 910.

The header decompressor 910 decompresses the compressed IP/UDP/RTP header in the data 915 of “compressed IP/UDP/RTP header+AMR header+Class A+Class B+Class C+padding 1” received from the packet assembler 920, completing a VoIP packet, and then delivers the VoIP packet to the upper layer or the core network.

The packet assembler 920 can determine whether to discard the assembled VoIP packet. That is, if the packet assembler 920 recognizes that there is an error in a header part while reconfiguring a VoIP packet by assembling data delivered from the respective radio bearers 990, 993, 995 and 997, the packet assembler 920 discards the VoIP packet without delivering it to the upper layer.

Even though the packet assembler 920 recognizes that there is an error in the Class-A data, the packet assembler 920 assembles a VoIP packet irrespective of the error and transmits the VoIP packet to the upper layer. This is because even though there is an error in the Class-A data, a codec can increase a call quality using the defective voice data.

### Fourth Embodiment

A fourth embodiment of the present invention proposes a structure in which a packet disassembler disassembles a VoIP packet into a header part, a Class-A part, a Class-B part, a Class-C part and transmits the respective parts through separate transport channels, and the packet disassembling is followed by header compression.

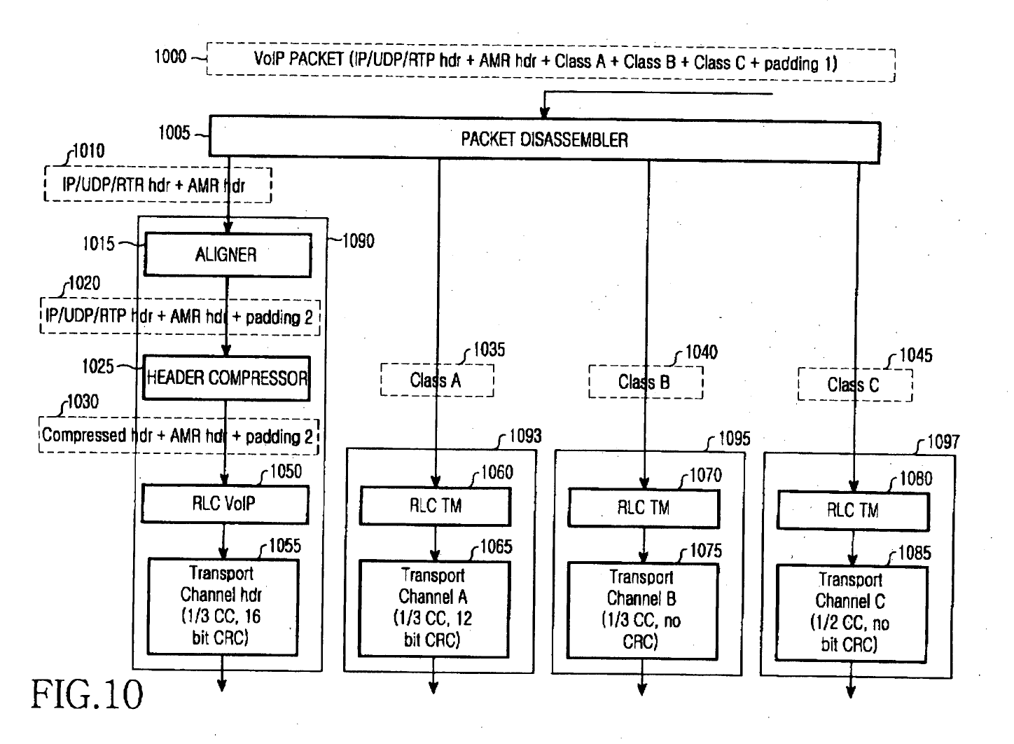

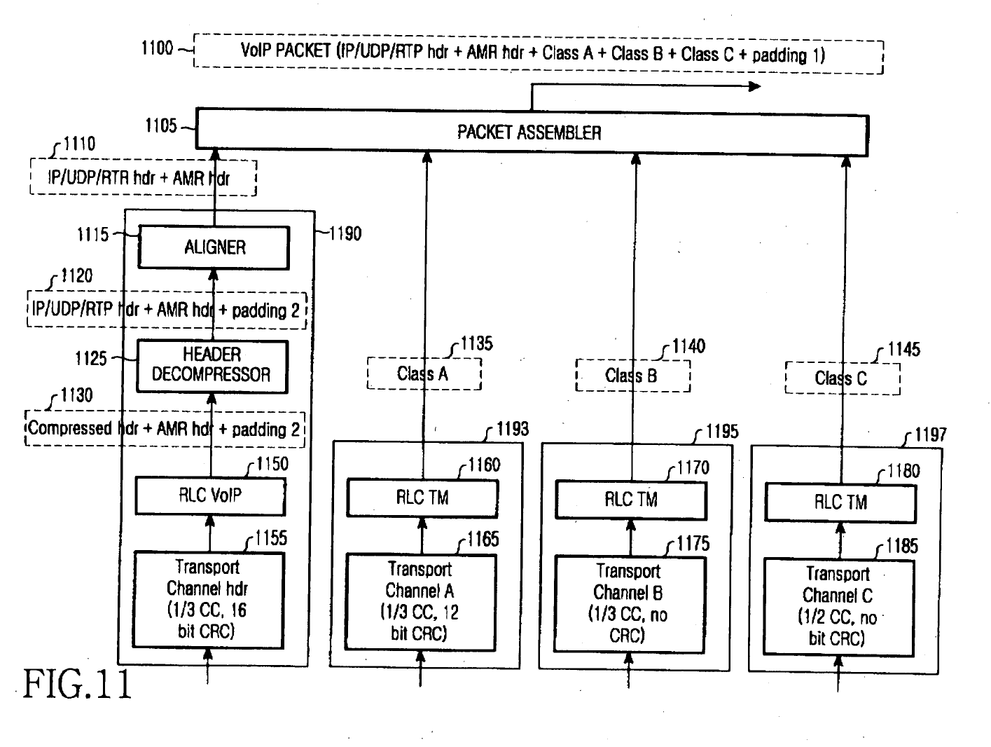

With reference to FIGS. 10 and 11, a description will now be made of a transceiver according to the fourth embodiment of the present invention. Unlike the third embodiment in which header compression is performed before packet disassembling, the fourth embodiment performs header compression after packet disassembling. Because the Class-A part, the Class-B part and the Class-C part are equivalent to those in the third embodiment in terms of operations and features, a detailed description thereof will be omitted.

FIG. 10 is a diagram illustrating a structure of a transmitter according to the fourth embodiment of the present invention. Referring to FIG. 10, the transmitter includes a packet disassembler 1005, a header radio bearer 1090 for processing header-part data, and a Class-A radio bearer 1093, a Class-B radio bearer 1095 and a Class-C radio bearer 1097, each of which processes data for its respective class.

The packet disassembler 1005 disassembles a VoIP packet 1000 of “IP/UDP/RTP header+AMR header+Class A+Class B+Class C+padding 1” into a header part and its respective class parts.

The header radio bearer 1090 receives the header part 1010 disassembled by the packet disassembler 1005, and includes an aligner 1015, a header compressor 1025, an RLC VoIP 1050 and a transport channel 1055 for header processing. The header radio bearer 1090 aligns and compresses the header part 1010 of “IP/UDP/RTP header+AMR header” and transmits the results over a radio channel.

That is, in the header radio bearer 1090 according to the fourth embodiment, the header compressor 1025 is arranged at the end of the aligner 1015. The aligner 1015 attaches a padding #2 to the header part 1010 of the VoIP packet 1000 received from the packet disassembler 1005. The header compressor 1025 compresses the padding #2-attached header part 1020, and outputs the compressed header 1030. The compressed header 1030 is delivered to the transport channel header 1055 via the RLC VoIP 1050. Here, the padding #2 byte-aligns the header part 1010 output from the packet disassembler 1005.

The Class-A radio bearer 1093, the Class-B radio bearer 1095 and the Class-C radio bearer 1097 are equivalent in operation to the corresponding elements illustrated in FIG. 8.

FIG. 11 is a diagram illustrating a structure of a receiver according to the fourth embodiment of the present invention. Referring to FIG. 11, the receiver includes a header radio bearer 1190, and a Class-A radio bearer 1193, a Class-B radio bearer 1195 and a Class-C radio bearer 1197, each of which processes data for its respective class, and a packet assembler 1105.

The header radio bearer 1190, which is comprised of an aligner 1115, a header decompressor 1125, an RLC VoIP 1150, and a transport channel 1155 for header processing, processes a header part “compressed IP/UDP/RTP header+AMR header” received through a radio channel and delivers the processing result to the packet assembler 1105. Specifically, in the header radio bearer 1190, the header part 1130 of “compressed IP/UDP/RTP header+AMR header+padding 2” output from the RLC VoIP 1150 is output to the header decompressor 1125. It should be noted that the output data 1130 is first delivered to the header decompressor 1125 which is arranged in front of the aligner 1115. The header decompressor 1125 decompresses the compressed IP/UDP/RTP header in the header-compressed data 1130, and delivers the result to the aligner 1115. The aligner 1115 removes the padding #2 from the output data 1120, and delivers the padding #2-removed header part 1100 of “IP/UDT/RTP header+AMR header” to the packet assembler 1105.

The packet assembler 1105 assembles the header-part data, the Class-A part data, the Class-B part data and the Class-C part data received from the respective radio bearers 1190, 1193, 1195 and 1197 into one VoIP packet 1100.

### Fifth Embodiment

A fifth embodiment of the present invention proposes a structure of a simplified transceiver in which a packet disassembler disassembles a VoIP packet only into a header part and a payload.

As described above, in the case of a VoIP packet, when there is an error in the header part, the full packet should be discarded. Even though there is an error in the payload part, the payload part has a use. That is, the header and the payload of the VoIP packet are obviously different from each other in terms of quality-of-service (QoS). Therefore, the fifth embodiment disassembles the VoIP packet only into a header part and a payload part, and creates transport channels according to the disassembling result.

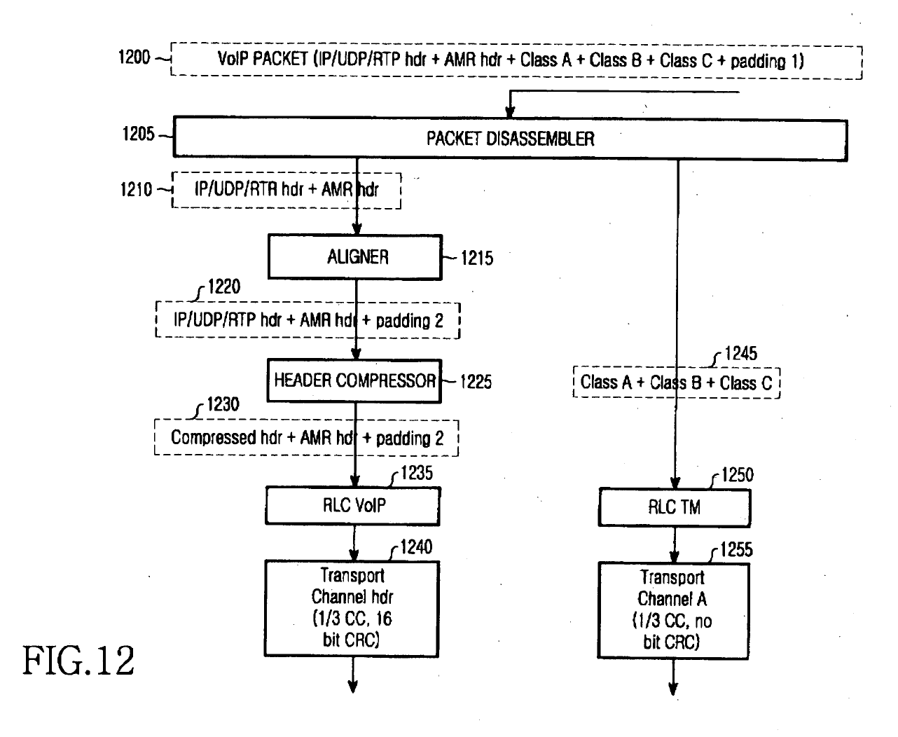

With reference to FIG. 12, a description will now be made of a transmitter according to the fifth embodiment of the present invention.

FIG. 12 is a diagram illustrating a structure of a transmitter according to the fifth embodiment of the present invention. Referring to FIG. 12, a packet disassembler 1205 disassembles a received VoIP packet 1200 into a header part 1210 of “IP/UDP/RTP header+AMR header” and a payload part 1245 of “Class A+Class B+Class C.”

An aligner 1215 attaches a padding #2 to the header part 1210 to byte-align the header part 1210. A header compressor 1225 compresses the aligned header part 1220 and delivers the compressed header part 1230 to a transport channel header 1240 through an RLC VoIP 1235. The transport channel 1240 for header processing should support CRC and will perform channel coding at a channel coding rate of, for example, 1/3.

The payload part 1245 is delivered to a transport channel A 1255 through an RLC TM 1250. The transport channel A 1255 does not use CRC, and performs channel coding at a channel coding rate of 1/3.

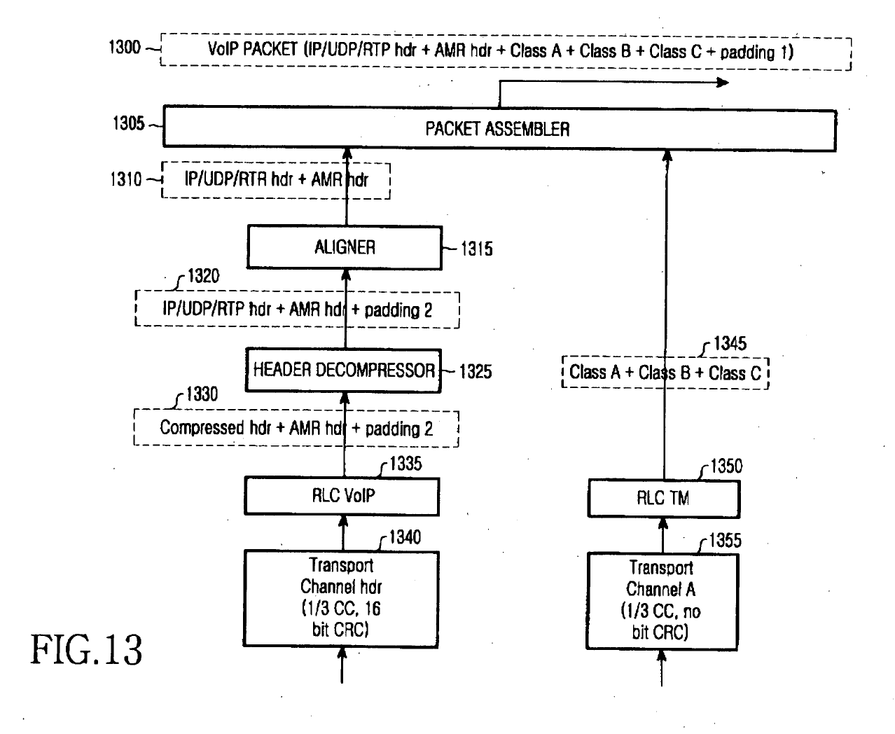

FIG. 13 is a diagram illustrating a structure of a receiver according to the fifth embodiment of the present invention. Referring to FIG. 13, data processed in a transport channel header 1340 and output from an RLC VoIP 1335 becomes a header-part data 1330 of “compressed IP/UDP/RTP header+AMR header+padding 2.” The output data 1330 is delivered to a header decompressor 1325. The header decompressor 1325 decompresses the compressed IP/UDP/RTP header in the output data 1330, and delivers header-decompressed data 1320 to an aligner 1315. The aligner 1315 removes the padding #2 from the header-decompressed data 1320 and delivers the padding #2-removed header part 1310 to a packet assembler 1305. Data processed in a transport channel A 1355 and output from an RLC TM 1350 becomes a payload part 1345, and the payload part 1345 is delivered to the packet assembler 1305. The packet assembler 1305 assembles the header part 1310 and the payload part 1345 into a VoIP packet 1300.

### Sixth Embodiment

A sixth embodiment of the present invention proposes a structure in which a packet disassembler disassembles a VoIP packet into a header part and a payload part and the packet disassembling precedes header compression.

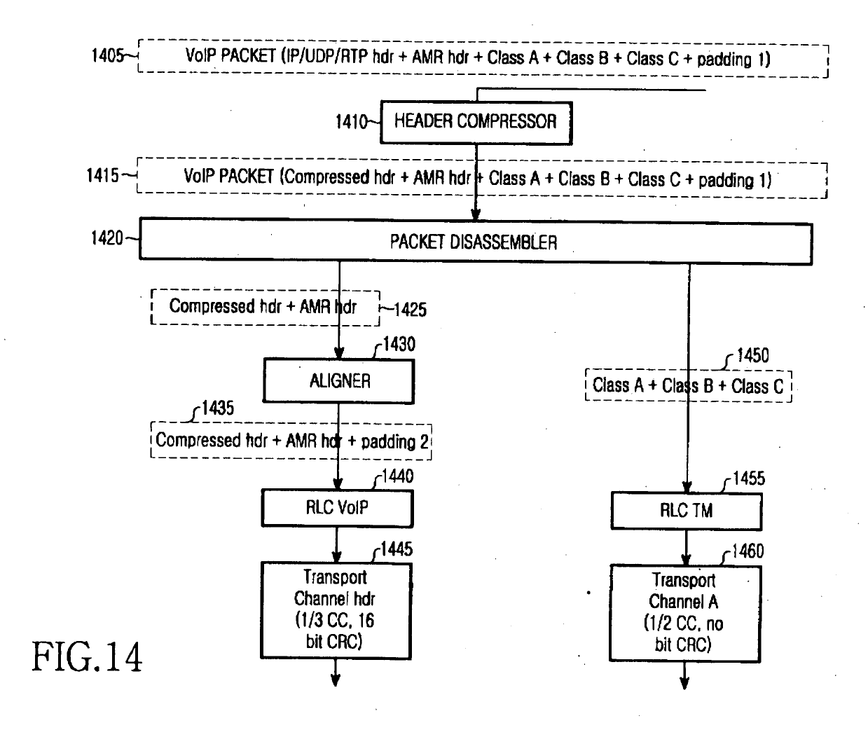

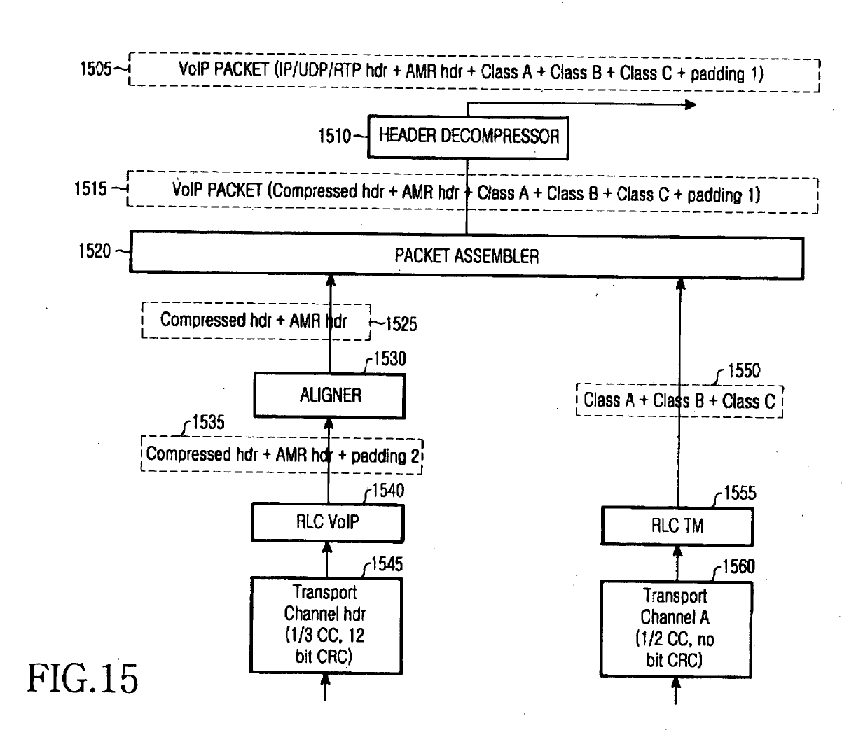

With reference to FIGS. 14 and 15, a description will now be made of a structure of a transceiver according to the sixth embodiment of the present invention. Because the sixth embodiment is substantially equivalent to the fifth embodiment, a detailed description thereof will be omitted.

FIG. 14 is a diagram illustrating a structure of a transmitter according to the sixth embodiment of the present invention. Referring to FIG. 14, the transmitter first compresses a header of a received VoIP packet 1405 using a header compressor 1410. The header compressor 1410 transmits the header-compressed data 1415 to a packet disassembler 1420. Then the packet disassembler 1420 disassembles the header-compressed data 1415 into a header part 1425 of “compressed header+AMR header” and a payload part 1450 of “Class A+Class B+Class C.”

An aligner 1430 byte-aligns the header part 1425 by attaching a padding #2 to the header part 1425. The byte-aligned header part 1435 is delivered to a transport channel header 1445 through an RLC VoIP 1440. The payload part 1450 delivered to a transport channel A 1460 through an RLC TM 1455.

FIG. 15 is a diagram illustrating a structure of a receiver according to the sixth embodiment of the present invention. Referring to FIG. 15, data processed in a transport channel header 1545 and output from an RLC VoIP 1540 becomes header-part data 1535 of “compressed IP/UDP/RTP header+AMR header+padding 2.” The output data 1535 is delivered to an aligner 1530. The aligner 1530 removes a padding #2 from the output data 1535 and delivers the padding #2-removed header part 1525 to a packet assembler 1520. Data processed in a transport channel A 1560 and output from an RLC TM 1555 becomes a payload part 1550, and the payload part 1550 is delivered to the packet assembler 1520. The packet assembler 1520 assembles the header part 1525 and the payload part 1550 into a VoIP packet 1515. A header of the assembled VoIP packet 1515 is decompressed into IP/UDP/RTP headers by a header decompressor 1515.

The foregoing transceiver according to the present invention can be applied not only to VoIP communication but also to packet service capable of obtaining a gain through UEP/UED. In particular, the scheme of separately processing a packet header and a payload as done in the fifth and sixth embodiments is advantageous in that the header part and the payload can be separately used. Even though there is an error in the payload, because the payload is useful, the payload can be used for packet service without being discarded.

As can be understood from the foregoing description, the present invention classifies voice packets for respective classes according to their importance (i.e. priority), and separately performs error protection and error detection on the classified voice packets for the respective classes, thereby providing service in a more efficient manner. The present invention adaptively provides service according to a frame format of a voice packet using an AMR codec, thereby maximizing efficiency of voice service based on a packet network.

While the invention has been shown and described with reference to a certain preferred embodiment thereof, it will be understood by those skilled in the art that various changes in form and details may be made therein without departing from the spirit and scope of the invention as defined by the appended claims.

1. A transmission apparatus for processing voice packets in a mobile communication system providing a voice service through a packet network, comprising:
a packet disassembler for disassembling the voice packets received from an upper entity into a plurality of data parts based on a header including frame information according to priorities;
at least one radio bearer unit for encoding a data part among the plurality of data parts and generating a error detection code according to the priorities, thereby generating radio channel data; and
at least one another radio bearer unit for encoding another data part except the data part according to the priorities, thereby generating radio channel data.

2. A transmission method for processing voice packets in a mobile communication system providing a voice service through a packet network, comprising:
disassembling voice packets received from an upper entity into a plurality of data parts based on a header including frame information according to priorities;
encoding at least one data part among the plurality of data parts and generating a error detection code according to the priorities, thereby generating radio channel data; and
encoding at least one another data part except the at least one data part according to the priorities, thereby generating radio channel data.

3. A transmission apparatus for processing a voice packet in a mobile communication system providing a voice service through a packet network, comprising:
a packet disassembler for disassembling a voice packet received from an upper system into first-class data, second-class data and third-class data based on an adaptive multi-rate (AMR) header including frame information which is divided into three parts according to priorities;
a first-class radio bearer unit for adding a padding bit for byte-aligning the first-class data delivered from the packet disassembler, and compressing a first-class protocol header, thereby generating a radio channel;
a second-class radio bearer unit for converting the second-class data delivered from the packet disassembler into a radio channel; and
a third-class radio bearer unit for converting the third-class data delivered from the packet disassembler into a radio channel.

4. The transmission apparatus of claim 3, wherein the packet disassembler removes the added padding bit according to the AMR header, analyzes a frame type field in the AMR header, and disassembles the padding bit-controlled voice packet into three classes according to the priorities.

5. The transmission apparatus of claim 3, wherein the first-class radio bearer unit comprises:
an aligner for adding a minimum number of padding bits to byte-align the first-class data delivered from the packet disassembler;
a header compressor for compressing the padding bit-removed first-class protocol header; and
a radio link control (RLC) layer for converting the first-class data including the compressed protocol header into a radio channel.

6. The transmission apparatus of claim 5, wherein the first-class radio bearer unit further includes a channel block for adding cyclic redundancy check (CRC) for performing error detection, and performing channel coding for error protection.

7. A reception apparatus for processing a voice packet for a voice service using an adaptive multi-rate (AMR) codec in a mobile communication system providing the voice service through a packet network, comprising:
three channel blocks for individually receiving signals through their associated radio channels;
a first-class radio bearer unit for converting a signal received from a first channel block from among the channel blocks into first-class data, decompressing a compressed protocol header in the first-class data, and removing a padding bit added for byte aligning;
a second-class radio bearer unit for converting a signal received from a second channel block from among the channel blocks into second-class data;
a third-class radio bearer unit for converting a signal received from a third channel block from among the channel blocks into third-class data; and
a packet assembler for generating one voice packet by assembling the first-class data, the second-class data and the third-class data delivered from the first-class radio bearer unit, the second-class radio bearer unit and the third-class radio bearer unit, respectively.

8. The reception apparatus of claim 7, wherein the packet assembler adds a padding bit according to an operation mode of the AMR codec, thereby generating the voice packet.

9. The reception apparatus of claim 7, wherein the first-class radio bearer unit comprises:
a radio link control (RLC) layer for converting into packet data a signal received from the first channel block from among the channel blocks;
a header decompressor for decompressing a compressed protocol header in the packet data delivered from the RLC layer, thereby detecting the first-class data; and
an aligner for removing the padding bit added for byte aligning from the first-class data delivered from the header decompressor.

10. A transmission apparatus for processing a voice packet in a mobile communication system providing a voice service through a packet network, comprising:
a header compressor for compressing a protocol header of a -voice packet received from an upper system;
a packet disassembler for disassembling the header-compressed voice packet based on an adaptive multi-rate (AMR) header including frame information which is divided into three parts according to priority;
a first-class radio bearer unit for adding a padding bit for byte-aligning first-class data delivered from the packet disassembler, thereby generating a radio channel;
a second-class radio bearer unit for processing second-class data delivered from the packet disassembler with a radio channel; and
a third-class radio bearer unit for processing third-class data delivered from the packet disassembler with a radio channel.

11. A reception apparatus for processing a voice packet in a mobile communication system providing a voice service through a packet network, comprising:
three channel blocks for individually receiving signals through their associated radio channels;
a first-class radio bearer unit for converting a signal received from a first channel block from among the channel blocks into first-class data, and removing a padding bit added for byte aligning from the first-class data;
a second-class radio bearer unit for converting a signal received from a second channel block from among the channel blocks into second-class data;
a third-class radio bearer unit for converting a signal received from a third channel block from among the channel blocks into third-class data;
a packet assembler for generating one voice packet by assembling the first-class data, the second-class data and the third-class data delivered from the first-class radio bearer unit, the second-class radio bearer unit and the third-class radio bearer unit, respectively; and
a header decompressor for decompressing a compressed protocol header in the voice packet generated by the packet assembler.

12. A method for receiving a voice packet in a mobile communication system providing a voice service through a packet network, comprising the steps of:
receiving from a core network, by a radio network controller (RNC), information related to a type of a voice frame of an adaptive multi-rate (AMR) codec and information related to an operation mode of the AMR codec for processing the voice frame;
classifying the voice packet received from the core network into three classes according to the information; and
setting up transport channels such that the classified three classes independently undergo error protection and error detection according to their priority.

13. The method of claim 12, wherein the RNC receives, from the core network, the information related to the type of a voice frame of the AMR codec and the information related to the operation mode of the AMR codec, and based on the received information, establishes a packet disassembler for disassembling the voice packet into three classes according to priority.

14. The method of claim 12, wherein the RNC receives, from the core network, a control message including the information related to the type of a voice frame of the AMR codec and the information related to the operation mode of the AMR codec for processing the voice frame, and based on the received information, establishes a packet assembler for assembling the three classes received through their associated transport channels into one voice packet.

15. A method for transmitting a voice packet in a mobile communication system providing a voice service through a packet network, comprising the steps of:
receiving from a core network, by a radio network controller (RNC), information related to type of a voice frame of an adaptive multi-rate (AMR) codec and information related to operation mode of the AMR codec for processing the voce frame;
compressing a protocol header of the voice packet, and classifying the voice packet received from the core network into three classes according to priority based on the information;
adding a padding bit for byte aligning to a first class from among the classified three classes, converting the padding bit-added first class into a radio channel, and setting up a first transport channel such that the radio channel undergoes error protection and error detection; and
converting second-class data and third-class data into separate radio channels, and setting up a second transport channel and a third transport channel such that the radio channels independently undergo error protection.

16. A transmission apparatus for processing a voice packet in a mobile communication system providing a voice service through a packet network, comprising:
a packet disassembler for disassembling a voice packet received from an upper system into first-class data, second class data and third-class data which are classified based on an adaptive multi-rate (AMR) header including frame information which is divided into three classes according to priority and into header-class data comprised of a protocol header and the AMR header in the voice packet;
a header radio bearer unit for adding a padding bit for byte aligning the header-class data delivered from the packet disassembler and compressing a header-class protocol header, thereby generating a radio channel;
a first-class radio bearer unit for converting the first-class data into a first radio channel;
a second-class radio bearer unit for converting the second-class data into a second radio channel; and
a third-class radio bearer unit for converting the third-class data into a third radio channel.

17. The transmission apparatus of claim 16, wherein the packet disassembler removes the added padding bit according to the AMR header, analyzes a frame type field in the AMR header, and disassembles the padding bit-controlled voice packet into three classes according to priority.

18. The transmission apparatus of claim 16, wherein the header radio bearer unit comprises:
an aligner for adding a minimum number of padding bits to byte-align the header-class data delivered from the packet disassembler;
a header compressor for compressing the padding bit-removed header-class protocol header; and
a radio link control (RLC) layer for converting the header-class data including the compressed protocol header into a radio channel.

19. The transmission apparatus of claim 14, wherein the header radio bearer unit further includes a channel block for adding cyclic redundancy check (CRC) for performing error detection in order to guarantee priority of the header-class data, and performing channel coding for error protection.

20. A reception apparatus for processing a voice packet for a voice service using an adaptive multi-rate (AMR) codec in a mobile communication system providing the voice service through a packet network, comprising:
four channel blocks for individually receiving signals through associated radio channels;
a header radio bearer unit for converting a signal received from a header channel block from among the channel blocks into header-class data, decompressing a compressed protocol header in the header-class data, and removing a padding bit added for byte aligning;
a first-class radio bearer unit for converting a signal received from a first channel block from among the channel blocks into first-class data;
a second-class radio bearer unit for converting a signal received from a second channel block from among the channel blocks into second-class data;
a third-class radio bearer unit for converting a signal received from a third channel block from among the channel blocks into third-class data; and
a packet assembler for generating one voice packet by assembling the header-class data, the first-class data, the second-class data and the third-class data.

21. The reception apparatus of claim 20, wherein the packet assembler adds a padding bit according to an operation mode of the AMR codec, thereby generating the voice packet.

22. The reception apparatus of claim 20, wherein the header-class radio bearer unit comprises:
a radio link control (RLC) layer for converting a signal received from the header channel block from among the channel blocks into the header-class data;
a header decompressor for decompressing a compressed protocol header in the header-class data delivered from the RLC layer; and
an aligner for removing a padding bit added for byte aligning from the header-class data delivered from the header decompressor.

23. A transmission apparatus for processing a voice packet in a mobile communication system providing a voice service through a packet network, comprising:
a header compressor for compressing a protocol header of a voice packet received from an upper system;
a packet disassembler for disassembling the header-compressed voice packet into first-class data, second-class data, third-class data and header-class data comprised of the protocol header and an adaptive multi-rate (AMR) header in the voice packet, based on the AMR header including frame information which is divided into three classes according to priority;
a header-class radio bearer unit for adding a padding bit for byte-aligning the header-class data delivered from the packet disassembler, thereby generating a radio channel;
a first-class radio bearer unit for converting the first-class data into a first radio channel;
a second-class radio bearer unit for converting the second-class data into a second radio channel; and
a third-class radio bearer unit for converting the third-class data into a third radio channel;

24. A reception apparatus for processing a voice packet in a mobile communication system providing a voice service through a packet network, comprising:
four channel blocks for individually receiving signals through their associated radio channels;
a header radio bearer unit for converting a signal received from a header channel block from among the channel blocks into header-class data, and removing a padding bit added for byte aligning from the header-class data;
a first-class radio bearer unit for converting a signal received from a first channel block from among the channel blocks into first-class data;
a second-class radio bearer unit for converting a signal received from a second channel block from among the channel blocks into second-class data;
a third-class radio bearer unit for converting a signal received from a third channel block from among the channel blocks into third-class data;
a packet assembler for generating one voice packet by assembling the header-class data, the first-class data, the second-class data and the third-class data; and
a header decompressor for decompressing a compressed protocol header in the voice packet generated by the packet assembler.

25. A method for receiving a voice packet in a mobile communication system providing a voice service through a packet network, comprising the steps of:
receiving from a core network, by a radio network controller (RNC), information related to a type of a voice frame of an adaptive multi-rate (AMR) codec and information related to operation mode of the AMR codec for processing the voice frame;
classifying the voice packet received from the core network into a header class and three classes having different priority according to the information; and
setting up transport channels such that the classified header class and the three classes independently undergo error protection and error detection according to their priority.

26. The method of claim 25, wherein the classifying step comprises the step of receiving, from the core network, the information related to the type of a voice frame of the AMR codec and the information related to the operation mode of the AMR codec for processing the voice frame, and based on the received information, classifying the voice packet into first, second and third classes according to priority and into a header class including a protocol header part and an AMR header.

27. The method of claim 25, wherein the RNC receives, from the core network, the information related to the type of a voice frame of the AMR codec and the information related to the operation mode of the AMR codec for processing the voice frame, and based on the received information, established a packet assembler for assembling into one voice packet the header class and the three classes received through their associated transport channels.

28. A method for transmitting a voice packet in a mobile communication system providing a voice service through a packet network, comprising the steps of:
receiving from a core network, by a radio network controller (RNC), information related to a type of a voice frame of an adaptive multi-rate (AMR) codec and information related to an operation mode of the AMR codec for processing the voice frame;
compressing a protocol header of the voice packet and classifying the voice packet received from the core network into a header class and three classes having different priority based on the information;
adding a padding bit for byte aligning to the header class from among the three classes thereby to generate a radio channel, and setting up a header-class channel such that the radio channel undergoes error protection and error detection; and
converting the first class, to the second class and the third class into separate radio channels, and setting up first, second and third transport channels such that the radio channels independently undergo error protection.

29. A transmission apparatus for processing a voice packet in a mobile communication system providing a voice service through a packet network, comprising:
a packet disassembler for disassembling a voice packet received from an upper system into payload-class data comprised of first, second and third classes which are classified based on an adaptive multi-rate (AMR) header including frame information which is divided into three classes according to priority and into header-class data comprised of a protocol header and the AMR header in the voice packet;
a header radio bearer unit for adding a padding bit for byte aligning to the header-class data, and compressing a header-class protocol header, thereby generating a radio channel; and
a payload radio bearer unit for processing first-class data, second-class data and third-class data having different priority for the payload-class data with a radio channel.

30. The transmission apparatus of claim 29, wherein the packet disassembler removes the added padding bit according to the AMR header, analyzes a frame type field in the AMR header, and disassembles the padding bit-controlled voice packet into a payload class comprised of three classes having different priority and a header class comprised of a protocol header and the AMR header.

31. The transmission apparatus of claim 29, wherein the header radio bearer comprises:
an aligner for adding a minimum number of padding bits to byte-align the header class delivered from the packet disassembler;
a header compressor for compressing a protocol header of the padding bit-removed header class; and
a radio link control (RLC) layer for converting the header class including the compressed protocol header into a radio channel.

32. The transmission apparatus of claim 31, wherein the header radio bearer unit further adds cyclic redundancy check (CRC) for performing error detection in order to guarantee priority of the header class, and performs channel coding for error protection.

33. A reception apparatus for processing a voice packet for a voice service using an adaptive multi-rate (AMR) codec in a mobile communication system providing the voice service through a packet network, comprising:
a header channel block and a payload channel block for individually receiving signals through associated radio channels;
a header radio bearer unit for converting a signal received from the header channel block into header-class data, decompressing a compressed protocol header in the header-class data, and removing a padding bit added for byte aligning;
a payload radio bearer unit for converting a signal received from the payload channel block into payload-class data; and
a packet assembler for generating one voice packet by assembling the header-class data delivered from the header radio bearer unit and the payload-class data delivered from the payload radio bearer unit.

34. The reception apparatus of claim 33, wherein the packet assembler adds a padding bit according to an operation mode of the AMR codec, thereby generating the voice packet.

35. The reception apparatus of claim 33, wherein the header radio bearer unit comprises:
a radio link control (RLC) layer for converting a signal received from the header channel block into packet data;
a header decompressor for decompressing a compressed protocol header in the packet data delivered from the RLC layer; and
an aligner for removing a padding bit added for byte aligning from header-class data delivered from the header decompressor.

36. A transmission apparatus for processing a voice packet in a mobile communication system providing a voice service through a packet network, comprising:
a header compressor for compressing a protocol header of a voice packet received from an upper system;
a packet disassembler for disassembling the header-compressed voice packet into a payload class comprised of first-class data, second-class data and third-class data classified based on an adaptive multi-rate (AMR) header including frame information which is divided into three classes according to priority and into a header class comprised of the protocol header and the AMR header in the voice packet;
a header radio bearer unit for adding a padding bit for byte-aligning the header-class data delivered from the packet disassembler, thereby generating a radio channel; and
a payload radio bearer unit for converting the payload-class data delivered from the packet disassembler into a radio channel.

37. A reception apparatus for processing a voice packet in a mobile communication system providing a voice service through a packet network, comprising:
a header channel block and a payload channel block for individually receiving signals through associated radio channels;
a header radio bearer unit for converting a signal received from the header channel block from among the channel blocks into header-class data, and removing a padding bit added for byte aligning from the header-class data;
a payload radio bearer unit for converting a signal received from the payload channel block into payload-class data;
a packet assembler for generating one voice packet by assembling the header-class data delivered from the header radio bearer unit and the payload-class data delivered from the payload radio bearer unit; and
a header decompressor for decompressing a compressed protocol header in the voice packet generated by the packet assembler.

38. A method for receiving a voice packet in a mobile communication system providing a voice service through a packet network, comprising the steps of:
receiving from a core network, by a radio network controller (RNC), information related to a type of a voice frame of an adaptive multi-rate (AMR) codec and information related to an operation mode of the AMR codec for processing the voice frame;
compressing a protocol header of the voice packet;
classifying the header-compressed voice packet into a payload class comprised of three classes having different priority and a header class, based on the information; and
setting up transport channels such that data for the header class and data for the payload class independently undergo error protection and error detection.

39. The method of claim 38, wherein the RNC receives, from the core network, the information related to the type of a voice frame of the AMR codec and the information related to the operation mode of the AMR codec, and based on the received information, establishes a packet disassembler for disassembling the voice packet into a payload class comprised of three classes classified according to priority and a header class comprised of a protocol header and a AMR header in the voice packet.

40. The method of claim 38, wherein the RNC receives, from the core network, the information related to the type of a voice frame of the AMR codec and the information related to the operation mode of the AMR codec for processing the voice frame, and based on the received information, establishes a packet assembler for assembling the data for the header class and the data for the payload class received through their associated transport channels into one voice packet.

41. A method for transmitting a voice packet in a mobile communication system providing a voice service through a packet network, comprising the steps of:
receiving from a core network, by a radio network controller (RNC), a control message including information related to a type of a voice frame of an adaptive multi-rate (AMR) codec and information related to an operation mode of the AMR codec for processing the voice frame;
compressing a protocol header of the voice packet, classifying the header-compressed voice packet into a payload class comprised of three classes having different priority and a header class, depending on the control message;
adding a padding bit for byte aligning to the header class to generate a radio channel, and setting up a header-class transport channel such that the radio channel undergoes error protection and error detection; and
converting the payload class into a radio channel, and setting up a payload-class transport channel such that the radio channel undergoes error protection and error detection.
